(19) United States
(12) Patent Application Publication
(10) Pub. No.: US 2026/0079136 A1
(43) Pub. Date: Mar. 19, 2026

(54) METHOD FOR OPTIMIZING A LIQUID CHROMATOGRAPHY SYSTEM AND SYSTEM FOR LIQUID CHROMATOGRAPHY

(71) Applicant: Dionex Softron GmbH

(72) Inventors: Martin Rendl, Munich (DE); Anne Morgenstern, Gilching (DE)

(21) Appl. No.: 18/888,369

(22) Filed: Sep. 18, 2024

(51) Int. Cl. G01N 30/32; B01D 15/18; G01N 30/02; G01N 30/72

(52) U.S. Cl. CPC G01N 30/32; B01D 15/1885; G01N 30/7233; G01N 2030/027; G01N 2030/326; G01N 2030/328

(57) ABSTRACT

The present invention relates to a method performed in a liquid chromatography system, the method comprising: in a first configuration (I), wherein a first separation column is fluidly connected to a separation pump and a detector, supplying a flow from the first separation column towards the detector by means of the separation pump in the first configuration (I); and switching the liquid chromatography system from the first configuration (I) to a second configuration (II), wherein the first separation column is fluidly connected to a second pump and to the detector, and supplying a flow from the first separation column towards the detector by means of the second pump in the second configuration (II). The present invention also relates to a corresponding system, use, computer program product, computer-readable medium and data carrier signal.

The present invention lies in the field of liquid chromatography and, more particularly, in the field of high-performance liquid chromatography. The present invention is directed to a method performed in a liquid chromatography system and to a system for liquid chromatography.

### BACKGROUND

From a very general viewpoint, liquid chromatography relates to an analytical method to separate a liquid sample into its constituent parts and then detect the constituents. For example, the respective proportions may be quantified. Generally, in liquid chromatography, separation between said respective proportions is achieved. A liquid chromatography system typically comprises at least one pump, a sample providing means, e.g. an autosampler, at least one separation column and a detector.

In order to perform liquid chromatography, a sample is added to one or more solvents and is subjected to flow, by means of the action of the pump, through the separation column and towards the detector. The pump that is utilized in a liquid chromatography system may deliver a gradient into the separation column. That it, the composition of the mobile phase, i.e. the solvent, going through the separation column may be changed over time using the separation pump. The time it takes for different constituents of a sample to pass through the separation column varies based on factors including their adherence to the column, the solvent, the solvent's flow rate, and its pressure. Typically, the stronger the interaction between a constituent and the separation column, the longer it takes to pass through. This variation enables the determination and analysis of the sample's constituents.

As the demand, e.g., for increased throughput may be important, the complexity of liquid chromatography systems may also increase. A tandem chromatography system generally comprises more than one separation column. The utilization of more than one separation column in a tandem chromatography system may reduce the time to result as well as costs, by parallelizing certain steps of the method for using a tandem chromatography system. For example, more than one column can be concurrently utilized, therefore, in an optimal case, doubling the throughput.

As an example, in a tandem chromatography system, a plurality of separation columns may be embedded in the same system and each separation column, within said plurality of separation columns, may be used in a sequential workflow, i.e. one after the other. As a consequence, chromatograms are obtained sequentially, i.e. one after the other, thus increasing the throughput of the system. However, the above-mentioned workflow may not assure that the quality of the analysis is uncompromised, but may merely concentrate on increasing the throughput of the system.

EP 2 449 372 B1 describes a liquid chromatography apparatus controllable to perform a chromatography process defined by target parameters and a sequence of operation procedures. The apparatus includes a process execution unit configured to execute the process using the set parameters and sequence, a determination unit to identify deviations between the actual and expected results of the chromatography procedure, and an adjustment unit to modify operational characteristics based on these deviations, thereby compensating for differences without changing the chromatography method itself. While this disclosure may provide satisfactory results in some cases, it has certain drawbacks and limitations. For example, while attempting to at least partially compensate for a difference between an expected target result and an actual result, the method used must remain unchanged. In addition, a number of target parameters are required and a database is used. In addition, mainly environmental biases (e.g. a significant change in ambient temperature or pressure) are corrected for.

U.S. Pat. No. 9,694,301 B2 relates to an apparatus for separating a liquid sample that includes a first separation unit for initial separation, a first fluid drive to move the sample through this unit, and a second separation unit positioned downstream for further separation. A second fluid drive at least partially conducts the sample through the second unit. The system also features a fluidic valve with interfaces connected to both fluid drives, allowing it to switch and facilitate sample separation. While this disclosure may provide advantages in improving the accuracy and/or precision of a liquid chromatography device, it may face more difficulties in guaranteeing increased throughput.

EP 0 403 680 B1 describes a device for optimizing liquid chromatographic separation of a sample. It features means for performing separations with selectable optimization parameters, such as mobile phase composition. Using measured chromatographic data and a mathematical model, the device derives and displays the sample's retention behavior. An input allows the user to select a desired optimization parameter, and the resulting chromatogram is calculated and displayed. This enables the user to determine the optimal parameter value for the best results. The process is iterated with refined data until the desired optimum is reached.

EP 0 577 033 A1 describes a method for adjusting analytical conditions in liquid chromatography. It detects the relationship between elution variation of a specific component and changes in analytical conditions. The retention time of the specific component is measured, and if it deviates from a reference range, the analytical condition is adjusted accordingly. This new condition is used for subsequent analyses. If the adjusted condition is outside the allowable range, an abnormality notification is triggered. Preferred adjustments include the elution solution changeover time, column temperature, or liquid feed pump flow rate.

U.S. Pat. No. 10,722,816 B2 relates to a method for setting the gradient delay volume (GDV) in a liquid chromatography system, particularly in high-performance liquid chromatography. The method involves determining or specifying a desired GDV. If this desired GDV differs from the system's actual GDV, the desired GDV is adjusted within a range from 0 to a maximum volume of a volume adjustment device. This document also discloses an automatic sampler designed to implement this method.

EP 1 342 202 A1 describes a method and device for automating the qualification process of chromatography systems. This process uses automation technology and regression analysis. A trained operator initially prepares the system, ensuring samples, solvents, and the separation column are ready for analysis. The qualification of the detector, solvent delivery system, sample manager, gradient dosing system, column heater, and system delay volume is then performed automatically, without further operator intervention. Regression analysis is conducted to calculate performance statistics, demonstrating the system's accuracy, linearity, and precision, and assessing its suitability for chromatographic analysis.

U.S. Pat. No. 9,442,098 B2 describes compositions and methods designed for chromatographic analysis and system quality control. These compositions include a reference material with a standardized mixture of two or more compounds, which serves for benchmarking and troubleshooting the chromatography system, rather than just providing a standard solution for a single analyte. The method involves generating a chromatogram from this reference material using the chromatography system. The resulting chromatogram is then compared to a benchmark for the reference material. If the difference between the chromatogram and the benchmark falls within an acceptable tolerance range, the system is considered to be functioning correctly, allowing for the analysis of other samples. If the difference exceeds the tolerance range, the system is flagged for troubleshooting based on the observed chromatogram discrepancies.

The teaching of U.S. Pat. No. 10,775,355 B2 is directed to a clinical diagnostic system including a sample preparation station for automatically preparing samples with analytes of interest, a liquid chromatography separation station featuring multiple liquid chromatography channels, and a sample preparation/liquid chromatography interface for loading prepared samples into these channels. The system also has a controller that manages sample assignments to predefined preparation workflows, each with a specific sequence of steps and required completion time based on the analytes involved. Additionally, the controller allocates a liquid chromatography channel to each prepared sample according to the analytes and plans an input sequence for the liquid chromatography channels to ensure that analytes from different channels elute in a non-overlapping sequence. Finally, the controller sets and starts a sequence that produces a sample output order consistent with the planned liquid chromatography channel input sequence.

US 2018/0229152 A1 discloses a parallel assembly of chromatography column modules housed within a rigid casing features a shared inlet and outlet. Each column module has a bed space filled with chromatography medium and includes built-in fluid conduits. When the modules are installed in the rigid casing, these conduits connect each bed space to the common inlet and outlet. The length and/or volume of the fluid conduit from the common inlet to each bed space, as well as from each bed space to the common outlet, are essentially identical across all modules in the parallel assembly.

Existing technologies are primarily directed to improving the performance of a liquid chromatography system in a limited range of terms. For example, existing technologies may relate to precision or efficiency of the workflow or number of results produced or correspondence to a give criterion or throughput (in liquid chromatography systems).

However, existing technologies may have certain shortcoming and disadvantages. In particular, the amount of time a detector is used may be far from optimal, resulting in a usage of this resource, which is far from optimal. Furthermore, in some prior art solutions, chromatograms may lack relevant signals.

The present invention alleviates at least in part some of the shortcomings of existing technologies. In particular, the present invention is directed at least in part in optimizing a liquid chromatography system in a broad range of terms, including high throughput, and/or consistent and reproducible chromatographic results and analyses, and/or limited data storage space utilization.

### SUMMARY OF THE INVENTION

In one aspect, the present invention relates to a method performed in a liquid chromatography system. The method comprises in a first configuration (I), wherein a first separation column is fluidly connected to a separation pump and a detector, supplying a flow from the first separation column towards the detector by means of the separation pump in the first configuration (I). The method further comprises switching the liquid chromatography system from the first configuration (I) to a second configuration (II), wherein the first separation column is fluidly connected to a second pump and to the detector. The method further comprises supplying a flow from the first separation column towards the detector by means of the second pump in the second configuration (II).

In one embodiment, in the first configuration (I), a second separation column may be fluidly connected to the second pump and to a waste. The method may comprise supplying a flow from the second separation column towards the waste by means of the second pump in the first configuration (I).

In the second configuration (II), the second separation column may be fluidly connected to the separation pump and to the waste and the method may further comprise supplying a flow from the second separation column towards the waste by means of the separation pump in the second configuration (II).

The method may comprise switching the liquid chromatography system from the second configuration (II) to a third configuration (III), wherein the first separation column may be fluidly connected to the second pump and to a waste. The method may further comprise supplying a flow from the first separation column towards the waste by means of the second pump in the third configuration (III).

In the third configuration (III) the second separation column may be fluidly connected to the separation pump and to the detector. The method may further comprise supplying a flow from the second separation column towards the detector by means of the separation pump in the third configuration (III).

The liquid chromatography system may be switched from the first configuration (I) to the second configuration (II) at a first switching time (T_{II}).

The liquid chromatography system may be switched from the second configuration (II) to the third configuration at a second switching time (T_{III}), wherein the second switching time (T_{III}) may be later than the first switching time (T_{II}).

A time difference t_{delay} between the second switching time (T_{III}) and the first switching time (T_{II}) may be based on a volume V₅ of the second separation column, on a volume V_{con} of fluidic connections connected to the second separation column, and on a flow rate F of the separation pump.

In other words, the time difference t_{delay} may correspond to the time a mobile phase flowing through the second separation column takes to traverse a volume given by the sum of the volume of the second separation column and of the fluidic connections connected to the second separation column. The time difference t_{delay} may therefore correspond to the time that the mobile phase flowing through the second separation column takes to go from the second pump to the detector. It may be particularly advantageous to take such time difference t_{delay} into consideration when detecting the mobile phase flowing through the second separation column with a detector, since the detector may be able to start detecting such mobile phase only after a time difference t_{delay} with respect to the second pump.

The time difference t_{delay} may fulfill the following equation:

t_{delay}=(V₅+V_{con})/F.

The time difference t_{delay} may amount to between 0 minutes and 100 minutes, preferably between 1 minute and 20 minutes, more preferably between 1 minute and 10 minutes.

At the first switching time (T_{II}), a flow rate F′ of the second pump may be substantially equal to the flow rate F of the separation pump.

A flow rate F′ of the second pump in the third configuration (III) may be substantially larger than the flow rate F of the separation pump in the third configuration (III).

The method may comprise switching the liquid chromatography system from the third configuration (III) to a fourth configuration (IV), wherein the first separation column may be fluidly connected to the separation pump and to a waste. The method further comprises supplying a flow from the first separation column towards the waste by means of the separation pump in the fourth configuration (IV).

In the fourth configuration (IV), the second separation column may be fluidly connected to the second pump and to the detector. The method may further comprise supplying a flow from the second separation column towards the detector by means of the second pump in the fourth configuration (IV).

The liquid chromatography system may be switched from the third configuration (III) to the fourth configuration (IV) at a third switching time (T_{IV}), wherein the third switching time (T_{IV}) may be later than the second switching time (T_{III}).

The liquid chromatography system may be switched from the fourth configuration (IV) back to the first configuration (I) at a fourth switching time (T_{I}), thereby forming a cyclic process and thereby ending a previous cycle and thereby starting a subsequent cycle. The fourth switching time (T_{I}) may be later than the third switching time (T_{IV}). A time difference t_{delay}′ between the fourth switching time (T_{I}) and the third switching time (T_{IV}) may be based on a volume V₈′ of the first separation column, on a volume V_{con}′ of fluidic connections connected to the first separation column, and on a flow rate F of the separation pump.

In other words, the time difference t_{delay}′ may correspond to the time a mobile phase flowing through the first separation column takes to traverse a volume given by the sum of the volume of the first separation column and of the fluidic connections connected to the first separation column. The time difference t_{delay}′ may therefore correspond to the time that the mobile phase flowing through the first separation column takes to go from the second pump to the detector. It may be particularly advantageous to take such time difference t_{delay}′ into consideration when detecting the mobile phase flowing through the second separation column with a detector, since the detector may be able to start detecting such mobile phase only after a time difference t_{delay}′ with respect to the second pump.

The time difference t_{delay}′ may fulfill the following equation:

t_{delay}′=(V₈′+V_{con}′)/F.

At the third switching time (T_{IV}), the flow rate F′ of the second pump may be substantially equal to the flow rate of the separation pump.

The flow rate F′ of the second pump in the first configuration (I) may be substantially larger than the flow rate F of the separation pump in the first configuration (I).

The time difference t_{delay}′ may amount to between 0 minutes and 100 minutes, preferably between 1 minute and 20 minutes, more preferably between 1 minute and 10 minutes.

The time difference t_{delay}′ may substantially coincide with the time difference t_{delay}.

The volume V₈′ of the first separation column substantially may coincide with the volume V₅ of the second separation column.

The volume V_{con}′ of fluidic connections connected to the first separation column may substantially coincide with the volume V_{con} of fluidic connections connected to the second separation column.

The method may comprise, after the fourth switching time T_{I}, switching the liquid chromatography system back to the second configuration at a subsequent first switching time T_{II}′. The subsequent first switching time T_{II}′ may later than the fourth switching time T_{I}. The time difference between the subsequent first switching time T_{II}′ and the fourth switching time T_{I} may be equal to t_{delay}.

The subsequent cycle may follow the same temporal sequence such that times T_{II}′, T_{III}′, T_{IV}v′, T_{I}′ of the subsequent cycle correspond, respectively, to the times T_{II}, T_{III}, T_{IV}, T_{I} of the previous cycle.

The method may comprise switching the liquid chromatography system from the first configuration (I) to the second configuration (II) by means of a controller.

The method may comprise switching the liquid chromatography system from the second configuration (II) to the third configuration (III) by means of the controller.

The method may comprise switching the liquid chromatography system from the third configuration (III) to the fourth configuration (IV) by means of the controller.

The method may comprise switching the liquid chromatography system from the fourth configuration (IV) to the first configuration (I) by means of the controller.

The method may comprise controlling the flow rate F of the first pump and the flow rate F′ of the second pump are controlled by the controller.

The liquid chromatography system may comprise a pre-column switching valve. The pre-column switching valve may comprise a plurality of ports and a plurality of connecting elements for interchangeably connecting the ports, wherein one port of the pre-column switching valve may be fluidly connected to the separation pump, one port of the pre-column switching valve may be fluidly connected to the second pump, one port of the pre-column switching valve may be fluidly connected to the first separation column, and one port of the pre-column switching valve may be fluidly connected to the second separation column.

In the first configuration (I), the port of the pre-column switching valve, which may be fluidly connected to the separation pump, may be connected to the port of the pre-column switching valve, which may be fluidly connected to the first separation column. In the first configuration (I), the port of the pre-column switching valve, which may be fluidly connected to the second pump, may be fluidly connected to the port of the pre-column switching valve, which may be fluidly connected to the second separation column.

In the second configuration (II), the port of the pre-column switching valve, which may be fluidly connected to the separation pump, may be fluidly connected to the port of the pre-column switching valve, which may be fluidly connected to the second separation column. In the second configuration (II), the port of the pre-column switching valve, which may be fluidly connected to the second pump, may be fluidly connected to the port of the pre-column switching valve, which may be fluidly connected to the first separation column.

The method may comprise switching, via the pre-column switching valve, the liquid chromatography system from the first configuration (I) to the second configuration (II) at the first switching time T_{II}.

The method may comprise switching, via the pre-column switching valve, the liquid chromatography system from the first configuration (I) to the second configuration (II) at the subsequent first switching time T_{II}′ in the subsequent cycle.

In the third configuration (III), the port of the pre-column switching valve, which may be fluidly connected to the separation pump, may be fluidly connected to the port of the pre-column switching valve, which may be fluidly connected to the second separation column. In the third configuration (III), the port of the pre-column switching valve, which may be fluidly connected to the second pump, may be fluidly connected to the port of the pre-column switching valve, which may be fluidly connected to the first separation column, in the third configuration (III).

In the fourth configuration (IV), the port of the pre-column switching valve, which may be fluidly connected to the separation pump, may be fluidly connected to the port of the pre-column switching valve, which may be fluidly connected to the first separation column. In the fourth configuration (IV), the port of the pre-column switching valve, which may be fluidly connected to the second pump, may be fluidly connected to the port of the pre-column switching valve, which may be fluidly connected to the second separation column.

The method may comprise switching, via the pre-column switching valve, the liquid chromatography system from the third configuration (III) to the fourth configuration (IV) at the third switching time T_{IV}.

The method may comprise switching, via the pre-column switching valve, the liquid chromatography system from the third configuration (III) to the fourth configuration (III) at the subsequent third switching time T_{IV}′ in the subsequent cycle.

The switching via the pre-column switching valve of the liquid chromatography system from the first configuration (I) to the second configuration (II) may be controlled by the controller.

The switching, via the pre-column switching valve, of the liquid chromatography system from the third configuration (III) to the fourth configuration (IV) may be controlled by the controller.

The liquid chromatography system may comprise a post-column switching valve. The post-column switching valve may comprise a plurality of ports and a plurality of connecting elements for interchangeably connecting the ports, wherein one port of the post-column switching valve may be fluidly connected to the first separation column, one port of the post-column switching valve may be fluidly connected to the second separation column, one port of the post-column switching valve may be fluidly connected to the waste, and one port of the post-column switching valve may be fluidly connected to the detector.

In the first configuration (I), the port of the post-column switching valve, which may be fluidly connected to the first separation column, may be fluidly connected to the port of the post-column switching valve, which may be fluidly connected to the detector. In the first configuration (I), the port of the post-column switching valve, which may be fluidly connected to the second separation column, may be fluidly connected to the port of the post-column switching valve, which may be fluidly connected to the waste.

In the second configuration (II), the port of the post-column switching valve, which may be fluidly connected to the first separation column, may be fluidly connected to the port of the post-column switching valve, which may be fluidly connected to the detector. In the second configuration (II), the port of the post-column switching valve, which may be fluidly connected to the second separation column, may be fluidly connected to the port of the post-column switching valve, which may be fluidly connected to the waste.

In the third configuration (III), the port of the post-column switching valve, which may be fluidly connected to the first separation column, may be fluidly connected to the port of the post-column switching valve, which may be fluidly connected to a waste. In the third configuration (III), the port of the post-column switching valve, which may be fluidly connected to the second separation column, may be fluidly connected to the port of the post-column switching valve, which may be fluidly connected to the detector.

The method may comprise switching, via the post-column switching valve, the liquid chromatography system from the second configuration (II) to the third configuration (III) at the second switching time T_{III}.

The method may comprise switching via the post-column switching valve switching the liquid chromatography system from the second configuration (II) to the third configuration (III) at the subsequent second switching time T_{III}′ in the subsequent cycle.

In the fourth configuration (IV), the port of the post-column switching valve, which may be fluidly connected to the first separation column, may be fluidly connected to the port of the post-column switching valve, which may be fluidly connected to a waste, in the fourth configuration (IV). In the fourth configuration (IV), the port of the post-column switching valve, which may be fluidly connected to the second separation column, may be fluidly connected to the port of the post-column switching valve, which may be fluidly connected to the detector.

The method may comprise switching, via the post-column switching valve, the liquid chromatography system from the fourth configuration (IV) to the first configuration (I) at the fourth switching time T_{I}.

The method may comprise switching, via the post-column switching valve, switching the liquid chromatography system from the fourth configuration (IV) to the first configuration (I) at the subsequent fourth switching time T_{I}′ in the subsequent cycle.

The switching, via the post-column switching valve, of the liquid chromatography system from the second configuration (II) to the third configuration (III) may be controlled by the controller.

The switching, via the post-column switching valve, of the liquid chromatography system from the fourth configuration (IV) to the first configuration (I) may be controlled by the controller.

t_{delay} may be essentially defined by a void volume of a separation column V_{column} and volumes of the fluidic connections V_{con} between said separation column and pre- and post-column switching valves and the flowrate of a gradient f_{grad}. Hence, t_{delay} may be the time that is required for the liquid fraction representing a solvent composition at the start of the the gradient to actually traverse through the separation column and reach the post-column valve.

The liquid chromatography system may comprise a double barrel electrospray source, wherein the double barrel electrospray source comprises a first barrel comprising the first separation column and a second barrel comprising the second separation column.

A terminal section of the first barrel may comprise a first emitter, the first emitter being configured to spray into the detector, and a terminal section of the second barrel may comprise a second emitter, the second emitter being configured to spray into the detector.

With regard to the double barrel electrospray configuration, the following should be understood: When supplying a high voltage to one of the barrels (e.g., to first barrel comprising the first separation column), this barrel will spray into the detector, e.g., into a mass spectrometer. Thus, particles passing through this barrel will pass to the detector, and this is understood to be encompassed by a fluidic connection between the corresponding separation column and the detector.

Furthermore, when no such high voltage is supplied to the barrel, the particles from the barrel are not passed to the detector. Thus, they cannot be further analyzed and they are lost for the process. For example, the respective liquid may simply evaporate. In the present specification, this is encompassed by the respective barrel/column being fluidly connected to waste.

The detector may comprise a mass spectrometry detector.

In the first configuration (I), the first barrel may be enabled to spray from the first emitter into the detector by a high voltage being applied to the first barrel in the first configuration (I).

In the second configuration (II), the first barrel may be enabled to spray from the first emitter into the detector by a high voltage being applied to the first barrel in the second configuration (II).

In the third configuration (III), the second barrel may be enabled to spray from the second emitter into the detector by a high voltage being applied to the second barrel in the third configuration (III).

In the fourth configuration (IV), the second barrel may be enabled to spray from the second emitter into the detector by a high voltage being applied to the second barrel in the fourth configuration (IV).

The high voltage may be in a range between 1 kV and 5 kV.

In electrospray ionization (ESI), a high voltage is applied to create a fine aerosol of charged droplets from a liquid sample. The range of high voltage typically applied for ESI is between 1 kV and 5 kV. This voltage range may be sufficient to induce the ionization of the sample and generate the charged droplets for mass spectrometric analysis. The exact voltage used can vary depending on the specific instrument and the nature of the sample being analyzed.

The method may comprise switching the liquid chromatography system from the second configuration (II) to the third configuration (III) at the second switching time T_{III}, by means of switching from the first barrel being enabled to spray from the first emitter into the detector to the second barrel being enabled to spray from the second emitter into the detector.

The method may comprise switching the liquid chromatography system from the second configuration (II) to the third configuration (III) at the subsequent second switching time T_{III}′ in the subsequent cycle, by means of switching from the first barrel being enabled to spray from the first emitter into the detector the second barrel being enabled to spray from the second emitter into the detector.

The method may comprise switching the liquid chromatography system from the fourth configuration (IV) to the first configuration (I) at the fourth switching time (T_{I}), by means of switching from the second barrel being enabled to spray from the second emitter into the detector to the first barrel being enabled to spray from the first emitter into the detector.

The method may comprise switching the liquid chromatography system from the fourth configuration (IV) to the first configuration (I) at the subsequent fourth switching time T_{I}′ in the subsequent cycle, by means of switching from the second barrel being enabled to spray from the second emitter into the detector to the first barrel being enabled to spray from the first emitter into the detector.

The liquid chromatography system may comprise an injection valve. The injection valve may comprise a plurality of ports and a plurality of connecting elements. One port of the injection valve may be fluidly connected to the second pump, one port of the injection valve may be fluidly connected to a port of the precolumn-switching valve. The method may comprise fluidly connecting the port of the injection valve, which may be fluidly connected to the second pump, to the port of the injection valve, which may be fluidly connected the precolumn-switching valve.

The injection valve may further comprise another plurality of ports. The method may comprise fluidly connecting the other plurality of ports to a plurality of sample reservoirs containing a plurality of samples.

The method may comprise the injection, by means of the injection valve, of a sample from a sample reservoir into the liquid chromatography system.

The method may comprise creating a flow of a sample from the injection valve towards the pre-column switching valve by means of the second pump.

The method may comprise switching from injecting a sample from a sample reservoir, by means of the injection valve, into the liquid chromatography system to injecting another sample from another sample reservoir, by means of the injection valve, into the liquid chromatography system.

The switching from injecting a sample from a sample reservoir, by means of the injection valve, into the liquid chromatography system to injecting another sample from another sample reservoir, by means of the injection valve, into the liquid chromatography system may happen at the first switching time (T_{II}).

The switching from injecting a sample from a sample reservoir, by means of the injection valve, into the liquid chromatography system to injecting another sample from another sample reservoir, by means of the injection valve, into the liquid chromatography system may happen at the subsequent first switching time (T_{II}′) in the subsequent cycle.

The switching from injecting a sample from a sample reservoir, by means of the injection valve, into the liquid chromatography system to injecting another sample from another sample reservoir, by means of the injection valve, into the liquid chromatography system may happen at the third switching time (T_{IV}).

The switching from injecting a sample from a sample reservoir, by means of the injection valve, into the liquid chromatography system to injecting another sample from another sample reservoir, by means of the injection valve, into the liquid chromatography system may happen at the subsequent third switching time (T_{IV}′) in the subsequent cycle.

The injection, by means of the injection valve, of a sample from a sample reservoir into the liquid chromatography system may be controlled by the controller. The switching from injecting a sample from a sample reservoir, by means of the injection valve, into the liquid chromatography system to injecting another sample from another sample reservoir by means of the injection valve into the liquid chromatography system may be controlled by the controller.

The method may comprise starting the provision of a gradient, by the separation pump, at the first switching time (T_{II}). The method may comprise comprises stopping the provision of a gradient, by the separation pump, at a time T_{grad. stop}. The time T_{grad. stop} may be later than the second switching time T_{III}. The time T_{grad. stop} may be earlier than the third switching time T_{IV}.

The method may comprise starting the provision of a gradient, by the separation pump, at the third switching time (T_{IV}). The method may comprise stopping the provision of a gradient, by the separation pump, at a time T_{grad. stop}′. The time T_{grad. stop}′ may be later than the fourth switching time T_{II}. The time T_{grad. stop}′ may be earlier than the subsequent first switching time T_{II}′ in the subsequent cycle.

The method may comprise controlling the start of the provision of the gradient and the stop of the provision of the gradient by the controller.

At the first switching time (T_{II}), a solvent composition delivered by the second pump may be substantially identical to a solvent composition delivered by the separation pump.

At the third switching time (T_{IV}), a solvent composition delivered by the second pump may be substantially identical to a solvent composition delivered by the separation pump.

The method may comprise starting the detection, by means of a detector, at the second switching time (T_{III}), wherein the method comprises stopping the detection, by means of the detector, at a detector stop time T_{dect. stop}. the detector stop time T_{dect. stop} may be later than the third switching time T_{IV}. The detector stop time T_{dect. stop} may be earlier than the fourth switching time T_{I}.

The method may comprise starting the detection, by means of the detector, at the fourth switching time T_{I}. The method may comprise stopping the detection, by means of the detector, at a further detector stop time T_{dect. stop}′. The time further detector stop time T_{dect. stop}′ is later than the subsequent first switching time T_{II}′ in the subsequent cycle. The further detector stop time T_{dect. stop}′ is earlier than the subsequent second switching time T_{III}′ in the subsequent cycle.

The time differences between any times, according to embodiments of the present invention, among the time at which a gradient may start to be provided, the time at which a gradient may stop to be provided, the time at which detection may start, and the time at which detection may stop may be advantageous for at least the following reasons.

Embodiments of the present invention relate, at least in part, to a workflow, wherein the time difference between the start of gradient delivery and the start of detection is substantially different from zero. This may not be the case in prior art liquid chromatography systems. In a general liquid chromatography system, comprising at least a separation pump, a separation column and a detector, a mobile phase may need a given amount of time to traverse a separation column. Such amount of time may in turn depend on the volume of the separation column, as well as on the fluidic connection linking the separation column to the pump and the separation column to the detector. In other words, the gradient delivery at the separation pump at a given point in time may be different from the gradient delivery at the detector. For example, right when the gradient starts being delivered from the separation pump, the gradient delivery at the pump is equal to the starting gradient delivery, while the gradient delivery at the detector will be equal to the starting gradient delivery at a later time. In many prior art tandem liquid chromatography systems, the detector may be configured to start the detection window as the pump starts delivering the gradient into the separation column. Such a workflow, however, may hinder an optimized utilization of the detector acquisition window, since the detector may actively be used beginning from when the pump starts delivering the gradient. In other words, the detector may actively be used beginning from when the gradient delivery at the separation pump is the starting gradient and not when the gradient delivery at the detector is the starting gradient. As an exemplary result, the detector may actively record before the gradient delivery at the detector is the starting gradient. Consequently, storage space for chromatograms may be used for data that may not be related to the sample or samples of interest. In many prior art tandem liquid chromatography systems, wherein the detector may be configured to start the detection window as the pump starts delivering the gradient into a separation column, it may happen that chromatograms lack fraction of the chromatographic peaks of the compound or compounds of interest. It may further occur that the chromatogram contains chromatographic peaks partly ascribable to compounds eluted from the separation column and partly from another separation column.

The method of the present invention may comprise controlling the start of the detection and the stop of the detection may be controlled by the controller.

The method may comprise utilizing an optimization procedure to optimize the time difference t_{delay} and/or the time difference t_{delay}′.

This may be particularly advantageous in light of at least some prior art technologies for at least the following reasons. Embodiments of the present invention relate, at least in part, to a workflow, wherein the time difference between the start of gradient delivery and the start of detection is substantially different from zero, and may be optimized. Embodiments of the present invention relate, more generally, at least in part, to optimizing a tandem liquid chromatography system. Embodiments of the present invention relate, at least in part, to optimizing a tandem liquid chromatography system and to ensuring, among others, an increase in throughput, and/or consistent and reproducible chromatographic results and analyses, and/or limited data storage space utilization.

The method may comprise controlling the steps comprised in the optimization procedure at least in part by the controller.

The method may comprise using a user interface, at least in part, in the steps of the optimization procedure.

The method may comprise acquiring a reference chromatogram.

The method may comprise acquiring a reference chromatogram containing at least some of the characteristic chromatographic peaks of a sample.

The method may comprise acquiring the reference by performing a linear gradient elution followed by an isocratic phase.

In other words, an optimization of t_{delay} can be employed by different means. In embodiments, a reference (i. e. scouting) run may be performed, which may be employed to obtain a reference chromatogram which contains all relevant peaks that are characteristic for the sample to be analyzed. This reference may be obtained by performing an LC sample run that is not optimized for maximized throughput using tandem LC. For instance, a linear gradient may be performed followed by an isocratic phase. Based on this reference chromatogram, the actual tandem LC workflow can be optimized by adjusting t_{delay}.

The optimization procedure may comprise carrying out an automatic optimization procedure.

The step of acquiring a reference chromatogram may precede the step of carrying out the automatic optimization procedure.

The automatic optimization procedure may comprise adjusting the time difference t_{delay} and adjusting the time difference t_{delay}′.

The method may comprise carrying out the adjusting by iterating the adjusting, wherein the iterating may performed until the number of detectable peaks or detectable compounds in an obtained chromatogram is maximized.

The method may comprise comparing the number of detectable peaks or detectable compounds in the obtained chromatogram to the number of detectable peaks or detectable compounds in the reference chromatogram.

The method may comprise comparing the number of detectable peaks or detectable compounds in an obtained chromatogram to the number of detectable peaks or detectable compounds in a reference chromatogram, wherein this reference chromatogram may be provided externally.

The detectable peaks or compounds may correspond to peptides, proteins, and/or other biomolecules.

The method may comprise carrying out the adjusting by iterating the adjusting, wherein the iterating may be performed by comparing the peaks in an obtained chromatogram with the peaks in the reference chromatogram until the match with the reference chromatogram is maximized.

The method may comprise carrying out the adjusting by iterating the adjusting, wherein the iterating may be performed by comparing the peaks in an obtained chromatogram with the peaks in the reference chromatogram until the match with the reference chromatogram is maximized, and wherein this reference chromatogram may be provided externally.

The method may comprise carrying out the adjusting by iterating the adjusting, wherein iterating may be performed at least in part until the number of detectable peaks or detectable compounds in an obtained chromatogram is maximized and at least in part by comparing the peaks in an obtained chromatogram with the peaks in the reference chromatogram until the match with the reference chromatogram is maximized.

The method may comprise carrying out the adjusting by iterating the adjusting, wherein iterating may be performed at least in part until the number of detectable peaks or detectable compounds in an obtained chromatogram is maximized and at least in part by comparing the peaks in an obtained chromatogram with the peaks in a reference chromatogram until the match with this reference chromatogram is maximized, wherein this reference chromatogram may be provided externally.

The method may comprise making use of threshold peak detection algorithms in the detection and/or the comparison of peaks.

The method may comprise using a threshold peak detection based on peak height or signal height.

The method may comprise using a threshold peak detection based on peak area or signal area.

The method may comprise using a threshold peak detection based on peak detection algorithms used in coding sequence.

The method may comprise using threshold peak detection algorithms comprising machine-learning techniques.

The optimization procedure may comprise utilizing at least in part a manual optimization procedure.

Overall, the method may comprise an automatic optimization procedure utilizing a software-driven approach where the chromatogram may be iteratively optimized by adjusting t_{delay} regarding one or multiple of the following conditions. (1) All peaks that may be detectable may be contained in the optimized chromatogram: the chromatogram may be optimized based on number of detectable peaks or compounds (e.g. identified peptides, proteins, etc.). (2) The chromatogram may be optimized based on closest match with reference chromatogram.

To this, threshold (peak/signal height or area based) similar to peak detection algorithm as used in state-of-the-art CDSs as well as machine-learning techniques may be employed.

The step of acquiring a reference chromatogram may precede the step of utilizing at least in part the manual optimization procedure.

The manual optimization procedure may comprise manually defining a detection-window by a user, wherein the detection window may comprise a time from the start of detection to the end of detection, manually defining a first and a last eluted compounds that should be present in an optimized chromatogram by the user. The optimized chromatogram may comprise an obtained chromatogram at the end of the optimization procedure.

The definition of the detection-window by the user may comprise manually cropping a portion of interest of an obtained chromatogram, wherein the defined detection-window may underlie the portion of interest of the obtained chromatogram, and wherein the cropping may be performed on a dedicated user interface.

A mass spectrometer and/or a diode array detector and/or another peak detection instrument may be used in defining the first and the last eluted compounds that may be present in the optimized chromatogram by the user.

The manual optimization procedure may comprise manually adjusting the time difference t_{delay} and the time difference t_{delay}′ by the user, wherein the controller may automatically optimize the rest of a workflow.

The manual optimization procedure may comprise manually adjusting the time difference t_{delay} and the time difference t_{delay}′ by the user, wherein the user manually may adjust the rest of a workflow.

Overall, the method may comprise a manual and/or user-based optimization procedure, according, for instance, to the following features. (1) A user may define a detection-window manually. E.g. in a dedicated user interface via manual cropping to the chromatogram portion of interest. To this end, visual aid can be provided. (2) A user may define first and last eluting compounds that may be included in the optimized chromatogram. To this end peek detection capabilities may be used (as in, e.g., a mass spectrometer or diode array detector). (3) A user may determine a delay time and may adjust this parameter in an input field of a dedicated user interface for a tandem workflow. The workflow may be programmed automatically taking delay time into account. (4) A user may determine delay time and programs workflow manually taking delay time into account.

The flow from the first separation column towards the detector in the first configuration (I) may have a flow rate in the range of 0 to 10 mL/min, preferably 0 to 100 μL/min, such as 0.1 to 10 μL/min.

The flow from the second separation column towards the waste may have a flow rate in the range of 0 to 10 mL/min, preferably 0 to 100 μL/min, such as 0.1 to 10 μL/min.

A pressure provided by the separation pump may be in the range of 100 bar to 2,000 bar, preferably 200 bar to 1,500 bar, such as 500 bar to 1,500 bar.

The method may comprise optimizing a solvent delivery.

Optimizing the solvent delivery may comprise optimizing a solvent composition at a start of a gradient delivery.

Optimizing the solvent delivery may comprise optimizing a solvent composition at an end of a gradient delivery.

Optimizing the solvent delivery may comprise optimizing a slope of a gradient delivery.

That is, e.g., in addition to shifting the position of the elution window in the temporal domain, also the size of the elution window may be optimized e.g. by adjusting the gradient start (% Bstart) and end solvent composition (% Bend) or the slope in parts of the gradient. Means to do this are also described in DE 10 2019 111783 A1, which is incorporated by reference in its entirety.

In a further aspect, the present invention relates to a system for liquid chromatography. The system comprises: a first separation column, a separation pump, and a detector. The first separation column is configured to be fluidly connected to the separation pump and the detector in a first configuration (I), wherein the system is configured to supply a flow from the first separation column towards the detector by means of the separation pump in the first configuration (I). The system is configured to switch the system from the first configuration (I) to a second configuration (II), wherein the first separation column is configured to be fluidly connected to the second pump and to the detector in the second configuration (II), and the system is configured to supply a flow from the first separation column towards the detector by means of the second pump in the second configuration (II).

The system may further comprise: a second separation column, and a waste. The second separation column may be configured to be fluidly connected to the second pump and to the waste in the first configuration (I), and the system may be configured to supply a flow from the second separation column towards the waste by means of the second pump in the first configuration (I).

The second separation column may be configured to be fluidly connected to the separation pump and to the waste in the second configuration (II), the system may be configured to supply a flow from the second separation column towards the waste by means of the separation pump in the second configuration (II).

The system may be configured to switch the system from the second configuration (II) to a third configuration (III), wherein the first separation column is configured to be fluidly connected to the second pump and to a waste, and the system may be configured to supply a flow from the first separation column towards the waste by means of the second pump in the third configuration (III).

In the third configuration (III) the second separation column may be configured to be fluidly connected to the separation pump and to the detector, and the system may be further configured to supply a flow from the second separation column towards the detector by means of the separation pump in the third configuration (III).

The system may be configured to switch the system from the first configuration (I) to the second configuration (II) at a first switching time (T_{II}).

The system may be configured to switch the system from the second configuration (II) to the third configuration at a second switching time (T_{III}), wherein the second switching time (T_{III}) is later than the first switching time (T_{II}).

A time difference t_{delay} between the second switching time (T_{III}) and the first switching time (T_{II}) may be based on a volume V₅ of the second separation column, on a volume V_{con} of fluidic connections connected to the second separation column, and on a flow rate F of the separation pump.

The time difference t_{delay} may fulfill the following equation: t_{delay}=(V₅+V_{con})/F.

The time difference t_{delay} may amount to between 0 minutes and 100 minutes, preferably between 1 minute and 20 minutes, more preferably between 1 minute and 10 minutes.

At the first switching time (T_{II}), a flow rate F′ of the second pump may be substantially equal to the flow rate F of the separation pump.

A flow rate F′ of the second pump in the third configuration (III) may be substantially larger than the flow rate F of the separation pump in the third configuration (III).

The system may be configured to switch the system from the third configuration (III) to a fourth configuration (IV), wherein the first separation column is fluidly connected to the separation pump and to a waste, and the system may be configured to supply a flow from the first separation column towards the waste by means of the separation pump in the fourth configuration (IV).

In the fourth configuration (IV), the second separation column may be fluidly connected to the second pump and to the detector, and the system may be configured to supply a flow from the second separation column towards the detector by means of the second pump in the fourth configuration (IV).

The system may be configured to switch the system from the third configuration (III) to the fourth configuration (IV) at a third switching time (T_{IV}), wherein the third switching time (T_{IV}) is later than the second switching time (T_{III}).

The system may be configured to switch the system from the fourth configuration (IV) back to the first configuration (I) at a fourth switching time (T_{I}), thereby forming a cyclic process and thereby ending a previous cycle and thereby starting a subsequent cycle, wherein the fourth switching time (T_{I}) is later than the third switching time (T_{IV}) and wherein a time difference t_{delay}′ between the fourth switching time (T_{I}) and the third switching time (T_{IV}) is based on a volume V₈′ of the first separation column, on a volume V_{con}′ of fluidic connections connected to the first separation column, and on a flow rate F of the separation pump.

The time difference t_{delay}′ may fulfill the following equation: t_{delay}′=(V₈′+V_{con}′)/F.

At the third switching time (T_{IV}), the flow rate F′ of the second pump may be substantially equal to the flow rate of the separation pump.

Therein the flow rate F′ of the second pump in the first configuration (I) may be substantially larger than the flow rate F of the separation pump in the first configuration (I).

The time difference t_{delay}′ may amount to between 0 minutes and 100 minutes, preferably between 1 minute and 20 minutes, more preferably between 1 minute and 10 minutes.

The time difference t_{delay}′ may substantially coincide with the time difference t_{delay}.

The volume V₈′ of the first separation column may substantially coincide with the volume V₅ of the second separation column.

The volume V_{con}′ of fluidic connections connected to the first separation column may substantially coincide with the volume V_{con} of fluidic connections connected to the second separation column.

The system, after the fourth switching time T_{I}, may be configured to switch the system back to the second configuration at a subsequent first switching time T_{II}′, wherein the subsequent first switching time T_{II}′ is later than the fourth switching time T_{I}, and wherein the time difference between the subsequent first switching time T_{II}′ and the fourth switching time T_{I} is equal to t_{delay}.

The subsequent cycle may follow the same temporal sequence such that times T_{II}′, T_{III}′, T_{IV}′, T_{I}′ of the subsequent cycle correspond, respectively, to the times T_{II}, T_{III}, T_{IV}, T_{I} of the previous cycle.

The system may comprise a controller, and the system may be configured to switch the system from the first configuration (I) to the second configuration (II) by means of the controller.

The system may be configured to switch the system from the second configuration (II) to the third configuration (III) by means of the controller.

The system may be configured to switch the system from the third configuration (III) to the fourth configuration (IV) by means of the controller.

The system may be configured to switch the system from the fourth configuration (IV) to the first configuration (I) by means of the controller.

The system may be configured to control the flow rate F of the first pump and the flow rate F′ of the second pump are controlled by the controller.

The liquid chromatography system may comprise a pre-column switching valve, wherein the pre-column switching valve comprises a plurality of ports and a plurality of connecting elements for interchangeably connecting the ports, wherein one port of the pre-column switching valve is fluidly connected to the separation pump, one port of the pre-column switching valve is fluidly connected to the second pump, one port of the pre-column switching valve is fluidly connected to the first separation column, and one port of the pre-column switching valve is fluidly connected to the second separation column.

In the first configuration (I), the port of the pre-column switching valve, which is fluidly connected to the separation pump, may be connected to the port of the pre-column switching valve, which is fluidly connected to the first separation column, and in the first configuration (I), the port of the pre-column switching valve, which is fluidly connected to the second pump, may be fluidly connected to the port of the pre-column switching valve, which is fluidly connected to the second separation column.

In the second configuration (II), the port of the pre-column switching valve, which is fluidly connected to the separation pump, may be fluidly connected to the port of the pre-column switching valve, which is fluidly connected to the second separation column, and in the second configuration (II), the port of the pre-column switching valve, which is fluidly connected to the second pump, may be fluidly connected to the port of the pre-column switching valve, which is fluidly connected to the first separation column.

The system may be configured to switch the system, via the pre-column switching valve, from the first configuration (I) to the second configuration (II) at the first switching time T_{II}.

The system may be configured to switch the system, via the pre-column switching valve, from the first configuration (I) to the second configuration (II) at the subsequent first switching time T_{II}′ in the subsequent cycle.

In the third configuration (III), the port of the pre-column switching valve, which is fluidly connected to the separation pump, may be fluidly connected to the port of the pre-column switching valve, which is fluidly connected to the second separation column, and in the third configuration (III), the port of the pre-column switching valve, which is fluidly connected to the second pump, may be fluidly connected to the port of the pre-column switching valve, which is fluidly connected to the first separation column, in the third configuration (III).

In the fourth configuration (IV), the port of the pre-column switching valve, which is fluidly connected to the separation pump, may be fluidly connected to the port of the pre-column switching valve, which is fluidly connected to the first separation column, and in the fourth configuration (IV), the port of the pre-column switching valve, which is fluidly connected to the second pump, may be fluidly connected to the port of the pre-column switching valve, which is fluidly connected to the second separation column.

The system may be configured to switch the system, via the pre-column switching valve, from the third configuration (III) to the fourth configuration (IV) at the third switching time T_{IV}.

The system may be configured to switch the system, via the pre-column switching valve, from the third configuration (III) to the fourth configuration (III) at the subsequent third switching time T_{IV}′ in the subsequent cycle.

The system may be configured to control the switching of via the pre-column switching valve from the first configuration (I) to the second configuration (II) by the controller.

The system may be configured to control the switching of the system, via the pre-column switching valve, from the third configuration (III) to the fourth configuration (IV) by the controller.

The system may comprise a post-column switching valve, wherein the post-column switching valve comprises a plurality of ports and a plurality of connecting elements for interchangeably connecting the ports, wherein one port of the post-column switching valve is fluidly connected to the first separation column, one port of the post-column switching valve is fluidly connected to the second separation column, one port of the post-column switching valve is fluidly connected to the waste, and one port of the post-column switching valve is fluidly connected to the detector.

In the first configuration (I), the port of the post-column switching valve, which is fluidly connected to the first separation column, may be fluidly connected to the port of the post-column switching valve, which is fluidly connected to the detector, and in the first configuration (I), the port of the post-column switching valve, which is fluidly connected to the second separation column, may be fluidly connected to the port of the post-column switching valve, which is fluidly connected to the waste.

In the second configuration (II), the port of the post-column switching valve, which is fluidly connected to the first separation column, may be fluidly connected to the port of the post-column switching valve, which is fluidly connected to the detector, and in the second configuration (II), the port of the post-column switching valve, which is fluidly connected to the second separation column, may be fluidly connected to the port of the post-column switching valve, which is fluidly connected to the waste.

In the third configuration (III), the port of the post-column switching valve, which is fluidly connected to the first separation column, may be fluidly connected to the port of the post-column switching valve, which is fluidly connected to a waste, and in the third configuration (III), the port of the post-column switching valve, which is fluidly connected to the second separation column, may be fluidly connected to the port of the post-column switching valve, which is fluidly connected to the detector.

The system may be configured to switch the system, via the post-column switching valve, from the second configuration (II) to the third configuration (III) at the second switching time T_{III}.

The system may be configured to switch the system via the post-column switching valve from the second configuration (II) to the third configuration (III) at the subsequent second switching time T_{III}′ in the subsequent cycle.

In the fourth configuration (IV), the port of the post-column switching valve, which is fluidly connected to the first separation column, may be fluidly connected to the port of the post-column switching valve, which is fluidly connected to a waste, in the fourth configuration (IV), and in the fourth configuration (IV), the port of the post-column switching valve, which is fluidly connected to the second separation column, may be fluidly connected to the port of the post-column switching valve, which is fluidly connected to the detector.

The system may be configured to switch the system, via the post-column switching valve, from the fourth configuration (IV) to the first configuration (I) at the fourth switching time T_{I}.

The system may be configured to switch the system, via the post-column switching valve, from the fourth configuration (IV) to the first configuration (I) at the subsequent fourth switching time T_{I}′ in the subsequent cycle.

The system may be configured to switch the system, via the post-column switching valve, from the second configuration (II) to the third configuration (III) is controlled by the controller.

The system may be configured to control the switching, via the post-column switching valve, from the fourth configuration (IV) to the first configuration (I) by the controller.

The system may comprise a double barrel electrospray source, wherein the double barrel electrospray source comprises a first barrel comprising the first separation column and a second barrel comprising the second separation column.

A terminal section of the first barrel may comprise a first emitter, the first emitter being configured to spray into the detector, and a second terminal section of the second barrel may comprise a second emitter, the second emitter being configured to spray into the detector.

The detector may comprise a mass spectrometry detector.

The system may be configured to enable the first barrel to spray from the first emitter into the detector in the first configuration (I) by applying a high voltage to the first barrel in the first configuration (I).

The system may be configured to enable the first barrel to spray from the first emitter into the detector in the second configuration (II) by applying a high voltage to the first barrel in the second configuration (II).

The system may be configured to enable the second barrel to spray from the second emitter into the detector in the third configuration (III) by applying a high voltage to the second barrel in the third configuration (III).

The system may be configured to enable the second barrel to spray from the second emitter into the detector in the fourth configuration (IV) by applying a high voltage to the second barrel in the fourth configuration (IV).

The high voltage may be in a range between 1 kV and 5 kV.

The system may be configured to switch system from the second configuration (II) to the third configuration (III) at the second switching time T_{III}, by means of switching from enabling the first barrel to spray from the first emitter into the detector to enabling the second barrel to spray from the second emitter into the detector.

The system may be configured to switch system from the second configuration (II) to the third configuration (III) at the subsequent second switching time T_{III}′ in the subsequent cycle, by means of switching from enabling the first barrel to spray from the first emitter into the detector to enabling the second barrel to spray from the second emitter into the detector.

The system may be configured to switch system from the fourth configuration (IV) to the first configuration (I) at the fourth switching time (T_{I}), by means of switching from enabling the second barrel to spray from the second emitter into the detector to enabling the first barrel to spray from the first emitter into the detector.

The system may be configured to switch system from the fourth configuration (IV) to the first configuration (I) at the subsequent fourth switching time T_{I}′ in the subsequent cycle, by means of switching from enabling the second barrel to spray from the second emitter into the detector to enabling the first barrel to spray from the first emitter into the detector.

The system may comprise an injection valve, wherein the injection valve comprises a plurality of ports and a plurality of connecting elements, and wherein one port of the injection valve is fluidly connected to the second pump, one port of the injection valve is fluidly connected to a port of the precolumn-switching valve, and the system may be configured to fluidly connect the port of the injection valve, which is fluidly connected to the second pump, to the port of the injection valve, which is fluidly connected the precolumn-switching valve.

The injection valve may further comprise another plurality of ports, and the system may be configured to fluidly connect the other plurality of ports to a plurality of sample reservoirs containing a plurality of samples.

The system may be configured to inject, by means of the injection valve, a sample from a sample reservoir into the liquid chromatography system.

The system may be configured to create a flow of a sample from the injection valve towards the pre-column switching valve by means of the second pump.

The system may be configured to switch from injecting a sample from a sample reservoir, by means of the injection valve, into the system to injecting another sample from another sample reservoir, by means of the injection valve, into the system.

The switching from injecting a sample from a sample reservoir, by means of the injection valve, into the system
to injecting another sample from another sample reservoir, by means of the injection valve, into the liquid chromatography system
may happen at the first switching time (T_{II}).

The switching from injecting a sample from a sample reservoir, by means of the injection valve, into the system
to injecting another sample from another sample reservoir, by means of the injection valve, into the liquid chromatography system
may happen at the subsequent first switching time (T_{II}′) in the subsequent cycle.

The switching from injecting a sample from a sample reservoir, by means of the injection valve, into the system
to injecting another sample from another sample reservoir, by means of the injection valve, into the liquid chromatography system
may happen at the third switching time (T_{IV}).

The switching from injecting a sample from a sample reservoir, by means of the injection valve, into the system
to injecting another sample from another sample reservoir, by means of the injection valve, into the liquid chromatography system
may happen at the subsequent third switching time (T_{IV}′) in the subsequent cycle.

The system may be configured to control the injection, by means of the injection valve, of a sample from a sample reservoir into the system is controlled by the controller, and
the system may be configured to control the switching from injecting a sample from a sample reservoir, by means of the injection valve, into the system
to injecting another sample from another sample reservoir by means of the injection valve into the system by the controller.

The system may be configured to start the provision of a gradient, by the separation pump, at the first switching time (T_{II}), and the system may be configured to stop the provision of a gradient, by the separation pump, at a time T_{grad. stop}, wherein the time T_{grad. stop} is later than the second switching time T_{III}, and wherein the time T_{grad. stop} is earlier than the third switching time T_{IV}.

The system may be configured to start the provision of a gradient, by the separation pump, at the third switching time (T_{IV}), and the system may be configured to stop the provision of a gradient, by the separation pump, at a time T_{grad. stop}′, wherein the time T_{grad. stop}′ is later than the fourth switching time T_{II}, and wherein the time T_{grad. stop}′ is earlier than the subsequent first switching time T_{II}′ in the subsequent cycle.

The system may be configured to control the start of the provision of the gradient and the stop of the provision of the gradient by the controller.

At the first switching time (T_{II}), a solvent composition delivered by the second pump may be substantially identical to a solvent composition delivered by the separation pump.

At the third switching time (T_{IV}), a solvent composition delivered by the second pump may be substantially identical to a solvent composition delivered by the separation pump.

The system may be configured to start the detection, by means of a detector, at the second switching time (T_{III}), and the system may be configured to stop the detection, by means of the detector, at a detector stop time T_{dect. stop}, wherein the detector stop time T_{dect. stop} is later than the third switching time T_{IV}, wherein the detector stop time T_{dect. stop} is earlier than the fourth switching time T_{I}.

The system may be configured to start the detection, by means of the detector, at the fourth switching time T_{I}, and the system may be configured to stop the detection, by means of the detector, at a further detector stop time T_{dect. stop}′, wherein the time further detector stop time T_{dect. stop}′ is later than the subsequent first switching time T_{II}′ in the subsequent cycle, wherein the further detector stop time T_{dect. stop}′ is earlier than the subsequent second switching time T_{III}′ in the subsequent cycle.

The system may be configured to control the start of the detection and the stop of the detection may by the controller.

The system may be configured to utilize an optimization procedure to optimize the time difference t_{delay} and/or the time difference t_{delay}′.

The system may be is configured to control the steps comprised in the optimization procedure at least in part by the controller.

The system may comprise a user interface.

The system may be configured to use the user interface, at least in part, in the steps of the optimization procedure.

The system may be configured to acquire a reference chromatogram.

The system may be configured to acquire a reference chromatogram containing at least some of the characteristic chromatographic peaks of a sample.

The system may be configured to acquire the reference by performing a linear gradient elution followed by an isocratic phase.

The optimization procedure may comprise carrying out an automatic optimization procedure, and the system may be configured to carry out the automatic optimization procedure.

The system may be configured to perform the step of acquiring a reference chromatogram before the step of carrying out the automatic optimization procedure.

The automatic optimization procedure may comprise adjusting the time difference t_{delay} and adjusting the time difference t_{delay}′, and the system may be configured to perform the adjusting of the time difference t_{delay} and the adjusting of the time difference t_{delay}′

The system may be configured to carry out the adjusting by iterating the adjusting, and wherein the system may be configured to perform the iterating until the number of detectable peaks or detectable compounds in an obtained chromatogram is maximized.

The system may be configured to compare the number of detectable peaks or detectable compounds in the obtained chromatogram to the number of detectable peaks or detectable compounds in the reference chromatogram.

The system may be configured to compare the number of detectable peaks or detectable compounds in an obtained chromatogram to the number of detectable peaks or detectable compounds in a reference chromatogram, wherein this reference chromatogram is provided externally.

The detectable peaks or compounds may correspond to peptides, proteins, and/or other biomolecules.

The system may be configured to carry out the adjusting by iterating the adjusting, and the system may be configured to perform the iterating by comparing the peaks in an obtained chromatogram with the peaks in the reference chromatogram until the match with the reference chromatogram is maximized.

The system may be configured to carry out the adjusting by iterating the adjusting, and the system may be configured to perform the iterating by comparing the peaks in an obtained chromatogram with the peaks in the reference chromatogram until the match with the reference chromatogram is maximized, wherein this reference chromatogram is provided externally.

The system may be configured to carry out the adjusting by iterating the adjusting, and the system may be configured to perform the iterating at least in part until the number of detectable peaks or detectable compounds in an obtained chromatogram is maximized and at least in part by comparing the peaks in an obtained chromatogram with the peaks in the reference chromatogram until the match with the reference chromatogram is maximized.

The system may be configured to carry out the adjusting by iterating the adjusting, and the system may be configured to perform the iterating at least in part until the number of detectable peaks or detectable compounds in an obtained chromatogram is maximized and at least in part by comparing the peaks in an obtained chromatogram with the peaks in a reference chromatogram until the match with this reference chromatogram is maximized, wherein this reference chromatogram is provided externally.

The system may be configured to make use of threshold peak detection algorithms in the detection and/or the comparison of peaks.

The system may be configured to use a threshold peak detection based on peak height or signal height.

The system may be configured to use a threshold peak detection based on peak area or signal area.

The system may be configured to use a threshold peak detection based on peak detection algorithms used in coding sequence.

The system may be configured to use threshold peak detection algorithms comprising machine-learning techniques.

The system may be configured to perform the optimization procedure utilizing at least in part a manual optimization procedure.

The system may be configured to perform the step of acquiring a reference chromatogram before the step of utilizing at least in part the manual optimization procedure.

The system may be configured to allow a manual optimization procedure comprising: manually defining a detection-window by a user, wherein the detection window comprises a time from the start of detection to the end of detection, manually defining a first and a last eluted compounds that should be present in an optimized chromatogram by the user, wherein the optimized chromatogram comprises an obtained chromatogram at the end of the optimization procedure.

The system may be configured to allow the definition of the detection-window by the user by manually cropping a portion of interest of an obtained chromatogram, wherein the defined detection-window underlies the portion of interest of the obtained chromatogram, and wherein the cropping is performed on a dedicated user interface.

The system may be configured to use a mass spectrometer and/or a diode array detector and/or another peak detection instrument in defining the first and the last eluted compounds that are present in the optimized chromatogram by the user.

The system may be configured to allow, in the manual optimization procedure, manually adjusting the time difference t_{delay} and the time difference t_{delay}′ by the user, and the controller may be configured to automatically optimize the rest of a workflow.

The system may be configured to allow, in the manual optimization procedure, manually adjusting the time difference t_{delay} and the time difference t_{delay}′ by the user, and be configured for the user to manually adjust the rest of a workflow.

The flow from the first separation column towards the detector in the first configuration (I) may have a flow rate in the range of 0 to 10 mL/min, preferably 0 to 100 μL/min, such as 0.1 to 10 μL/min.

The flow from the second separation column towards the waste may have a flow rate in the range of 0 to 10 mL/min, preferably 0 to 100 μL/min, such as 0.1 to 10 μL/min.

In the first configuration (I), a pressure provided by the separation pump may be in the range of 100 bar to 2,000 bar, preferably 200 bar to 1,500 bar, such as 500 bar to 1,500 bar.

The controller may be configured to control the system to carry out the method described above.

The system may be adapted to carry out the method described above.

The system may be adapted to carry out any given step of the method described above.

The system may be configured to optimize a solvent delivery.

Optimizing the solvent delivery may comprise optimizing a solvent composition at a start of a gradient delivery.

Optimizing the solvent delivery may comprise optimizing a solvent composition at an end of a gradient delivery.

Optimizing the solvent delivery may comprise optimizing a slope of a gradient delivery.

In another aspect, the present invention relates to a use of the liquid chromatography system for tandem liquid chromatography.

The use may be to carry out the method as recited in any of the preceding method embodiments.

The pre-column switching valve may be used to switch the liquid chromatography system from the first configuration to the second configuration at the first switching time T_{II}.

The post-column switching valve may be used to switch the liquid chromatography system from the second configuration to the third configuration at the second switching time T_{I}.

The pre-column switching valve may be used to switch the liquid chromatography system from the third configuration to the fourth configuration at the third switching time T_{IV}.

The post-column switching valve may be used to switch the liquid chromatography system from the fourth configuration to the first configuration at the fourth switching time T_{I}.

The controller may be used to automatically execute a workflow according to embodiments of the present invention.

In another aspect, the present invention relates to a computer program product comprising instructions which, when executed by a processor, cause the processor to control a system for liquid chromatography to carry out the method according to embodiments of the present invention.

In another aspect, the present invention relates to a computer-readable medium comprising instructions which, when executed by a processor, cause the processor to control a system for liquid chromatography to carry out the method according to embodiments of the present invention.

In another aspect, the present invention relates to a data carrier signal carrying the computer program product according to an embodiment of the present invention.

The present technology is also described by the following numbered embodiments.

Below, reference will be made to method embodiments. These embodiments are abbreviated by the letter “M” followed by a number. Whenever reference is herein made to “method embodiments”, these embodiments are meant.
M1. A method performed in a liquid chromatography system, the method comprising:
   in a first configuration (I), wherein a first separation column is fluidly connected to a separation pump and a detector, supplying a flow from the first separation column towards the detector by means of the separation pump in the first configuration (I), and
   switching the liquid chromatography system from the first configuration (I) to a second configuration (II), wherein the first separation column is fluidly connected to a second pump and to the detector, and supplying a flow from the first separation column towards the detector by means of the second pump in the second configuration (II).
M2. The method according to the preceding embodiment,
   wherein in the first configuration (I) a second separation column is fluidly connected to the second pump and to a waste, and wherein the method further comprises supplying a flow from the second separation column towards the waste by means of the second pump in the first configuration (I).
M3. The method according to any of the preceding embodiments, with the features of embodiment M2,
   wherein in the second configuration (II), the second separation column is fluidly connected to the separation pump and to the waste, wherein the method further comprises supplying a flow from the second separation column towards the waste by means of the separation pump in the second configuration (II).
M4. The method according to any of the preceding embodiments,
   wherein the method comprises switching the liquid chromatography system from the second configuration (II) to a third configuration (III), wherein the first separation column is fluidly connected to the second pump and to a waste, and wherein the method further comprises supplying a flow from the first separation column towards the waste by means of the second pump in the third configuration (III).
M5. The method according to the preceding embodiment, wherein in the third configuration (III) the second separation column is fluidly connected to the separation pump and to the detector, wherein the method further comprises supplying a flow from the second separation column towards the detector by means of the separation pump in the third configuration (III).
M6. The method according to any of the preceding embodiments, wherein the liquid chromatography system is switched from the first configuration (I) to the second configuration (II) at a first switching time (T_{II}).
M7. The method according to the preceding embodiment and with the features of embodiment M4,
   wherein the liquid chromatography system is switched from the second configuration (II) to the third configuration at a second switching time (T_{III}),
   wherein the second switching time (T_{III}) is later than the first switching time (T_{II}).
M8. The method according to the preceding embodiment,
   wherein a time difference t_{delay} between the second switching time (T_{III}) and the first switching time (T_{II}) is based on a volume V₅ of the second separation column, on a volume V_{con} of fluidic connections connected to the second separation column, and on a flow rate F of the separation pump.
M9. The method according to the preceding embodiment,
   wherein the time difference t_{delay} fulfills the following equation:

t_{delay}=(V₅+V_{con})/F.
M10. The method according to any of the preceding embodiments, with the features of embodiment M7,
   wherein the time difference t_{delay} amounts to between 0 minutes and 100 minutes, preferably between 1 minute and 20 minutes, more preferably between 1 minute and 10 minutes.
M11. The method according to any of the preceding embodiments, with the features of embodiment M6,
   wherein at the first switching time (T_{II}), a flow rate F′ of the second pump is substantially equal to the flow rate F of the separation pump.
M12. The method according to any of the preceding embodiments, with the features of embodiment M4,
   wherein a flow rate F′ of the second pump in the third configuration (III) is substantially larger than the flow rate F of the separation pump in the third configuration (III).
M13. The method according to any of the preceding embodiments, with the features of embodiment M4,
   wherein the method comprises switching the liquid chromatography system from the third configuration (III) to a fourth configuration (IV), wherein the first separation column is fluidly connected to the separation pump and to a waste, and wherein the method further comprises supplying a flow from the first separation column towards the waste by means of the separation pump in the fourth configuration (IV).
M14. The method according to the preceding embodiment,
   wherein in the fourth configuration (IV), the second separation column is fluidly connected to the second pump and to the detector, and wherein the method further comprises supplying a flow from the second separation column towards the detector by means of the second pump in the fourth configuration (IV).
M15. The method according to any of the preceding embodiments with the features of embodiment M13,
   wherein the liquid chromatography system is switched from the third configuration (III) to the fourth configuration (IV) at a third switching time (T_{IV}), wherein the third switching time (T_{IV}) is later than the second switching time (T_{III}).
M16. The method according to the any of the preceding embodiments, with the features of embodiment M13,
   wherein the liquid chromatography system is switched from the fourth configuration (IV) back to the first configuration (I) at a fourth switching time (T_{I}), thereby forming a cyclic process and thereby ending a previous cycle and thereby starting a subsequent cycle,
   wherein the fourth switching time (T_{I}) is later than the third switching time (T_{IV}) and wherein a time difference t_{delay}′ between the fourth switching time (T_{I}) and the third switching time (T_{IV}) is based on a volume V₈′ of the first separation column, on a volume V_{con}′ of fluidic connections connected to the first separation column, and on a flow rate F of the separation pump.
M17. The method according to any of the preceding embodiments with the features of embodiment M16,
   wherein the time difference t_{delay}′ fulfills the following equation:

t_{delay}′=(V₈′+V_{con}′)/F.
M18. The method according to any of the preceding embodiments, with the features of embodiment M15,
   wherein at the third switching time (T_{IV}), the flow rate F′ of the second pump is substantially equal to the flow rate of the separation pump.
M19. The method according to any of the preceding embodiments, with the features of embodiment M16,
   wherein the flow rate F′ of the second pump in the first configuration (I) is substantially larger than the flow rate F of the separation pump in the first configuration (I).
M20. The method according to any of the preceding embodiments, with the features of embodiment M16,
   wherein the time difference t_{delay}′ amounts to between 0 minutes and 100 minutes, preferably between 1 minute and 20 minutes, more preferably between 1 minute and 10 minutes.
M21. The method according to any of the preceding embodiments, with the of features of embodiments M16,
   wherein the time difference t_{delay}′ substantially coincides with the time difference t_{delay}.
M22. The method according to any of the preceding embodiments, with the of features of embodiments M16,
   wherein the volume V₈′ of the first separation column substantially coincides with the volume V₅ of the second separation column.
M23. The method according to any of the preceding embodiments, with the of features of embodiments M16,
   wherein the volume V_{con}′ of fluidic connections connected to the first separation column substantially coincides with the volume V_{con} of fluidic connections connected to the second separation column.
M24. The method according to any of the preceding embodiments, with the features of embodiment M16,
   wherein the method comprises, after the fourth switching time T_{I}, switching the liquid chromatography system back to the second configuration at a subsequent first switching time T_{II}′,
   wherein the subsequent first switching time T_{II}′ is later than the fourth switching time T_{I}, and
   wherein the time difference between the subsequent first switching time T_{II}′ and the fourth switching time T_{I} is equal to t_{delay}.
M25. The method according to any of the preceding embodiments, with the features of embodiment M24,
   wherein the subsequent cycle follows the same temporal sequence such that times T_{II}′, T_{III}′, T_{IV}′, T_{I}′ of the subsequent cycle correspond, respectively, to the times T_{II}, T_{III}, T_{IV}, T_{I} of the previous cycle.
M26. The method according to any of the preceding embodiments,
   wherein the method comprises switching the liquid chromatography system from the first configuration (I) to the second configuration (II) by means of a controller.
M27. The method according to the preceding embodiment and with the features of embodiment M4,
   wherein the method comprises switching the liquid chromatography system from the second configuration (II) to the third configuration (III) by means of the controller.
M28. The method according to any of the preceding embodiments and with the features of embodiments M13 and M26,
   wherein the method comprises switching the liquid chromatography system from the third configuration (III) to the fourth configuration (IV) by means of the controller.
M29. The method to any of the preceding embodiments and with the features of embodiments M7 and M26,
   wherein the method comprises switching the liquid chromatography system from the fourth configuration (IV) to the first configuration (I) by means of the controller.
M30. The method according any of the preceding embodiments and with the features of embodiments M7 and M11 and M26,
   wherein method comprises controlling the flow rate F of the first pump and the flow rate F′ of the second pump are controlled by the controller.
M31. The method according to any of the preceding embodiments,
   wherein the liquid chromatography system comprises a pre-column switching valve,
   wherein the pre-column switching valve comprises a plurality of ports and a plurality of connecting elements for interchangeably connecting the ports,
   wherein
      one port of the pre-column switching valve is fluidly connected to the separation pump,
      one port of the pre-column switching valve is fluidly connected to the second pump,
      one port of the pre-column switching valve is fluidly connected to the first separation column,
      one port of the pre-column switching valve is fluidly connected to the second separation column.
M32. The method according to any of the preceding embodiments, with the features of embodiment M31,
   wherein in the first configuration (I), the port of the pre-column switching valve, which is fluidly connected to the separation pump, is connected to the port of the pre-column switching valve, which is fluidly connected to the first separation column, and
   wherein in the first configuration (I), the port of the pre-column switching valve, which is fluidly connected to the second pump, is fluidly connected to the port of the pre-column switching valve, which is fluidly connected to the second separation column.
M33. The method according to any of the preceding embodiments, with the features of embodiment M31,
   wherein in the second configuration (II), the port of the pre-column switching valve, which is fluidly connected to the separation pump, is fluidly connected to the port of the pre-column switching valve, which is fluidly connected to the second separation column, and wherein in the second configuration (II), the port of the pre-column switching valve, which is fluidly connected to the second pump, is fluidly connected to the port of the pre-column switching valve, which is fluidly connected to the first separation column.
M34. The method according to any of the preceding embodiments, with the features of embodiment M6 and M31,
   wherein the method comprises switching, via the pre-column switching valve, the liquid chromatography system from the first configuration (I) to the second configuration (II) at the first switching time T_{II}.
M35. The method according to any of the preceding embodiments, with the features of embodiment M24 and M31,
   wherein the method comprises switching, via the pre-column switching valve, the liquid chromatography system from the first configuration (I) to the second configuration (II) at the subsequent first switching time T_{II}′ in the subsequent cycle.
M36. The method according to any of the preceding embodiments, with the features of embodiment M31 and M4,
   wherein in the third configuration (III), the port of the pre-column switching valve, which is fluidly connected to the separation pump, is fluidly connected to the port of the pre-column switching valve, which is fluidly connected to the second separation column, and
   wherein in the third configuration (III), the port of the pre-column switching valve, which is fluidly connected to the second pump, is fluidly connected to the port of the pre-column switching valve, which is fluidly connected to the first separation column, in the third configuration (III).
M37. The method according to any of the preceding embodiments, with the features of embodiment M13 and M31,
   wherein in the fourth configuration (IV), the port of the pre-column switching valve, which is fluidly connected to the separation pump, is fluidly connected to the port of the pre-column switching valve, which is fluidly connected to the first separation column, and
   wherein in the fourth configuration (IV), the port of the pre-column switching valve, which is fluidly connected to the second pump, is fluidly connected to the port of the pre-column switching valve, which is fluidly connected to the second separation column.
M38. The method according to any of the preceding embodiments, with the features of embodiment M16 and M31,
   wherein the method comprises switching, via the pre-column switching valve, the liquid chromatography system from the third configuration (III) to the fourth configuration (IV) at the third switching time T_{IV}.
M39. The method according to any of the preceding embodiments, with the features of embodiment M25 and M31,
   wherein the method comprises switching, via the pre-column switching valve, the liquid chromatography system from the third configuration (III) to the fourth configuration (III) at the subsequent third switching time T_{IV}′ in the subsequent cycle.
M40. The method according to any of the preceding embodiments, with the features of embodiments M26, M34 and M35,
   wherein the switching via the pre-column switching valve of the liquid chromatography system from the first configuration (I) to the second configuration (II) is controlled by the controller.
M41. The method according to any of the preceding embodiments, with the features of embodiments M26, M38 and M39,
   wherein the switching, via the pre-column switching valve, of the liquid chromatography system from the third configuration (III) to the fourth configuration (IV) is controlled by the controller.
M42. The method according to any of the preceding embodiments,
   wherein the liquid chromatography system comprises a post-column switching valve,
   wherein the post-column switching valve comprises a plurality of ports and a plurality of connecting elements for interchangeably connecting the ports,
   wherein
      one port of the post-column switching valve is fluidly connected to the first separation column,
      one port of the post-column switching valve is fluidly connected to the second separation column,
      one port of the post-column switching valve is fluidly connected to the waste,
      one port of the post-column switching valve is fluidly connected to the detector.
M43. The method according to any of the preceding embodiments, with the features of embodiment M42,
   wherein in the first configuration (I), the port of the post-column switching valve, which is fluidly connected to the first separation column, is fluidly connected to the port of the post-column switching valve, which is fluidly connected to the detector, and
   wherein in the first configuration (I), the port of the post-column switching valve, which is fluidly connected to the second separation column, is fluidly connected to the port of the post-column switching valve, which is fluidly connected to the waste.
M44. The method according to any of the preceding embodiments, with the features of embodiment M42,
   wherein in the second configuration (II), the port of the post-column switching valve, which is fluidly connected to the first separation column, is fluidly connected to the port of the post-column switching valve, which is fluidly connected to the detector, and
   wherein in the second configuration (II), the port of the post-column switching valve, which is fluidly connected to the second separation column, is fluidly connected to the port of the post-column switching valve, which is fluidly connected to the waste.
M45. The method according to any of the preceding embodiments, with the features of embodiment M4 and M42,
   wherein in the third configuration (III), the port of the post-column switching valve, which is fluidly connected to the first separation column, is fluidly connected to the port of the post-column switching valve, which is fluidly connected to a waste, and
   wherein in the third configuration (III), the port of the post-column switching valve, which is fluidly connected to the second separation column, is fluidly connected to the port of the post-column switching valve, which is fluidly connected to the detector.
M46. The method according to any of the preceding embodiments, with the features of embodiment M4 and M42,
   wherein the method comprises switching, via the post-column switching valve, the liquid chromatography system from the second configuration (II) to the third configuration (III) at the second switching time T_{I}.
M47. The method according to any of the preceding embodiments, with the features of embodiment M25 and M42,
   wherein the method comprises switching via the post-column switching valve switching the liquid chromatography system from the second configuration (II) to the third configuration (III) at the subsequent second switching time T_{III}′ in the subsequent cycle.
M48. The method according to any of the preceding embodiments, with the features of embodiments M13 and M42,
   wherein in the fourth configuration (IV), the port of the post-column switching valve, which is fluidly connected to the first separation column, is fluidly connected to the port of the post-column switching valve, which is fluidly connected to a waste, in the fourth configuration (IV), and
   wherein in the fourth configuration (IV), the port of the post-column switching valve, which is fluidly connected to the second separation column, is fluidly connected to the port of the post-column switching valve, which is fluidly connected to the detector.
M49. The method according to any of the preceding embodiments, with the features of embodiments M16 and M42,
   wherein the method comprises switching, via the post-column switching valve, the liquid chromatography system from the fourth configuration (IV) to the first configuration (I) at the fourth switching time T_{I}.
M50. The method according to any of the preceding embodiments, with the features of embodiments M25 and M42,
   wherein the method comprises switching, via the post-column switching valve, switching the liquid chromatography system from the fourth configuration (IV) to the first configuration (I) at the subsequent fourth switching time T_{I}′ in the subsequent cycle.
M51. The method according to any of the preceding embodiments, with the features of embodiments M4, M26 and M42,
   wherein the switching, via the post-column switching valve, of the liquid chromatography system from the second configuration (II) to the third configuration (III) is controlled by the controller.
M52. The method according to any of the preceding embodiments, with the features of embodiments M13, M26 and M42,
   wherein the switching, via the post-column switching valve, of the liquid chromatography system from the fourth configuration (IV) to the first configuration (I) is controlled by the controller.
M53. The method according to any of the embodiments from M1 to M41 with the features of embodiments M2,
   wherein the liquid chromatography system comprises a double barrel electrospray source, and
   wherein the double barrel electrospray source comprises a first barrel comprising the first separation column and a second barrel comprising the second separation column.
M54. The method according to the preceding embodiment,
   wherein a terminal section of the first barrel comprises a first emitter, the first emitter being configured to spray into the detector and
   wherein a terminal section of the second barrel comprises a second emitter, the second emitter being configured to spray into the detector.
M55. The method according to the preceding embodiment,
   wherein the detector comprises a mass spectrometry detector.
M56. The method according to any of the 2 preceding embodiments,
   wherein, in the first configuration (I), the first barrel is enabled to spray from the first emitter into the detector by a high voltage being applied to the first barrel in the first configuration (I).
M57. The method according to of any of the 3 preceding embodiments,
   wherein, in the second configuration (II), the first barrel is enabled to spray from the first emitter into the detector by a high voltage being applied to the first barrel in the second configuration (II).
M58. The method according to any of the 4 embodiments and with the features of embodiment M7,
   wherein, in the third configuration (III), the second barrel is enabled to spray from the second emitter into the detector by a high voltage being applied to the second barrel in the third configuration (III).
M59. The method according to any of the 5 preceding embodiments and with the features of embodiment M13,
   wherein, in the fourth configuration (IV), the second barrel is enabled to spray from the second emitter into the detector by a high voltage being applied to the second barrel in the fourth configuration (IV).
M60. The method according to any of the preceding 4 embodiments, wherein the high voltage is in a range between 1 kV and 5 kV.
M61. The method according to any of the preceding embodiments with the features of embodiments M7, M57 and M58,
   wherein method the comprises switching the liquid chromatography system from the second configuration (II) to the third configuration (III) at the second switching time T_{III}, by means of switching from the first barrel being enabled to spray from the first emitter into the detector to the second barrel being enabled to spray from the second emitter into the detector.
M62. The method according to any of the preceding embodiments with the features of embodiments M57, M58 and M25,
   wherein method the comprises switching the liquid chromatography system from the second configuration (II) to the third configuration (III) at the subsequent second switching time T_{III}′ in the subsequent cycle,
   by means of switching from the first barrel being enabled to spray from the first emitter into the detector the second barrel being enabled to spray from the second emitter into the detector.
M63. The method according to any of the preceding embodiments with the features of embodiments M16, M56 and M59,
   wherein method the comprises switching the liquid chromatography system from the fourth configuration (IV) to the first configuration (I) at the fourth switching time (T_{I}),
   by means of switching from the second barrel being enabled to spray from the second emitter into the detector to the first barrel being enabled to spray from the first emitter into the detector.
M64. The method according to any of the preceding embodiments with the features of embodiments M56, M59 and M25,
   wherein method the comprises switching the liquid chromatography system from the fourth configuration (IV) to the first configuration (I) at the subsequent fourth switching time T_{I}′ in the subsequent cycle,
   by means of switching from the second barrel being enabled to spray from the second emitter into the detector to the first barrel being enabled to spray from the first emitter into the detector.
M65. The method according to any of the preceding embodiments,
   wherein the liquid chromatography system comprises an injection valve,
   wherein the injection valve comprises a plurality of ports and a plurality of connecting elements,
   and wherein
      one port of the injection valve is fluidly connected to the second pump,
      one port of the injection valve is fluidly connected to a port of the precolumn-switching valve,
   wherein the method comprises
      fluidly connecting the port of the injection valve, which is fluidly connected to the second pump, to the port of the injection valve, which is fluidly connected the precolumn-switching valve.
M66. The method according to any of the preceding embodiments, with the features of embodiment M65,
   wherein the injection valve further comprises another plurality of ports, and
   wherein the method comprises fluidly connecting the other plurality of ports to a plurality of sample reservoirs containing a plurality of samples.
M67. The method according to any of the preceding embodiments, with the features of embodiment M65,
   wherein the method comprises the injection, by means of the injection valve, of a sample from a sample reservoir into the liquid chromatography system.
M68. The method according to any of the preceding embodiments, with the features of embodiment M67,
   wherein the method comprises creating a flow of a sample from the injection valve towards the pre-column switching valve by means of the second pump.
M69. The method according to any of the preceding embodiments, with the features of embodiment M67,
   wherein the method comprises switching from injecting a sample from a sample reservoir, by means of the injection valve, into the liquid chromatography system to injecting another sample from another sample reservoir, by means of the injection valve, into the liquid chromatography system.
M70. The method according to any of the preceding embodiments, with the features of embodiments M7 and M67,
   wherein the switching from injecting a sample from a sample reservoir, by means of the injection valve, into the liquid chromatography system
   to injecting another sample from another sample reservoir, by means of the injection valve, into the liquid chromatography system
   happens at the first switching time (T_{II}).
M71. The method according to any of the preceding embodiments, with the features of embodiments M25 and M67,
   wherein the switching from injecting a sample from a sample reservoir, by means of the injection valve, into the liquid chromatography system
   to injecting another sample from another sample reservoir, by means of the injection valve, into the liquid chromatography system
   happens at the subsequent first switching time (T_{II}′) in the subsequent cycle.
M72. The method according to any of the preceding embodiments, with the features of embodiments M15 and M67,
   wherein the switching from injecting a sample from a sample reservoir, by means of the injection valve, into the liquid chromatography system
   to injecting another sample from another sample reservoir, by means of the injection valve, into the liquid chromatography system
   happens at the third switching time (T_{IV}).
M73. The method according to any of the preceding embodiments, with the features of embodiments M25 and M67,
   wherein the switching from injecting a sample from a sample reservoir, by means of the injection valve, into the liquid chromatography system
   to injecting another sample from another sample reservoir, by means of the injection valve, into the liquid chromatography system
   happens at the subsequent third switching time (T_{IV}′) in the subsequent cycle.
M74. The method according to any of the preceding eight embodiments with the features of embodiment M26,
   wherein the injection, by means of the injection valve, of a sample from a sample reservoir into the liquid chromatography system is controlled by the controller, and
   wherein the switching from injecting a sample from a sample reservoir, by means of the injection valve, into the liquid chromatography system
   to injecting another sample from another sample reservoir by means of the injection valve into the liquid chromatography system is controlled by the controller.
M75. The method according to any of the preceding embodiments, with the features of embodiments M7, M15 and M16,
   wherein the method comprises starting the provision of a gradient, by the separation pump, at the first switching time (T_{II}),
   wherein the method comprises stopping the provision of a gradient, by the separation pump, at a time T_{grad. stop},
   wherein the time T_{grad. stop} is later than the second switching time T_{III}, and
   wherein the time T_{grad. stop} is earlier than the third switching time T_{IV}.
M76. The method according to any of the preceding embodiments, with the features of embodiments M25,
   wherein the method comprises starting the provision of a gradient, by the separation pump, at the third switching time (T_{IV}),
   wherein the method comprises stopping the provision of a gradient, by the separation pump, at a time T_{grad. stop}′,
   wherein the time T_{grad. stop}′ is later than the fourth switching time T_{II}, and
   wherein the time T_{grad. stop}′ is earlier than the subsequent first switching time T_{II}′ in the subsequent cycle.
M77. The method according to any of the preceding embodiments with the features of embodiment M26,
   wherein the method comprises controlling the start of the provision of the gradient and the stop of the provision of the gradient by the controller.
M78. The method according to any of the preceding embodiments with the features of embodiment M6,
   wherein at the first switching time (T_{II}), a solvent composition delivered by the second pump is substantially identical to a solvent composition delivered by the separation pump.
M79. The method according to any of the preceding embodiments with the features of embodiment M15,
   wherein at the third switching time (T_{IV}), a solvent composition delivered by the second pump is substantially identical to a solvent composition delivered by the separation pump.
M80. The method according to any of the preceding embodiments, with the features of embodiments M7 and M16,
   wherein the method comprises starting the detection, by means of a detector, at the second switching time (T_{III}),
   wherein the method comprises stopping the detection, by means of the detector, at a detector stop time T_{dect. stop},
   wherein the detector stop time T_{dect. stop} is later than the third switching time T_{IV},
   wherein the detector stop time T_{dect. stop} is earlier than the fourth switching time T_{I}.
M81. The method according to the preceding embodiment, with the features of embodiments M25,
   wherein the method comprises starting the detection, by means of the detector, at the fourth switching time T_{I},
   wherein the method comprises stopping the detection, by means of the detector, at a further detector stop time T_{dect. stop}′,
   wherein the time further detector stop time T_{dect. stop}′ is later than the subsequent first switching time T_{II}′ r in the subsequent cycle,
   wherein the further detector stop time T_{dect. stop}′ is earlier than the subsequent second switching time T_{III}′ in the subsequent cycle.
M82. The method according to any of the preceding embodiments with the features of embodiment M26,
   wherein the method comprises controlling the start of the detection and the stop of the detection may be controlled by the controller.
M83. The method according to any of the preceding embodiments,
   wherein the method comprises utilizing an optimization procedure to optimize the time difference t_{delay} and/or the time difference t_{delay}′.
M84. The method according to any of the preceding embodiments, with the features of embodiments M26 and M83,
   wherein the method comprises controlling the steps comprised in the optimization procedure at least in part by the controller.
M85. The method according to any of the preceding embodiments, with the features of embodiment M83,
   wherein the method comprises using a user interface, at least in part, in the steps of the optimization procedure.
M86. The method according to any of the preceding embodiments, with the features of embodiment M83,
   wherein the method comprises acquiring a reference chromatogram.
M87. The method according to any of the preceding embodiments, with the features of embodiment M83,
   wherein the method comprises acquiring a reference chromatogram containing at least some of the characteristic chromatographic peaks of a sample.
M88. The method according to any of the preceding embodiments, with the features of embodiment M83,
   wherein the method comprises acquiring the reference by performing a linear gradient elution followed by an isocratic phase.
M89. The method according to any of the preceding embodiments, with the features of embodiment M83,
   wherein the optimization procedure comprises carrying out an automatic optimization procedure.
M90. The method according to any of the preceding embodiments, with the features of embodiments M86 and M89,
   wherein the step of acquiring a reference chromatogram precedes the step of carrying out the automatic optimization procedure.
M91. The method according to any of the preceding embodiments, with the features of embodiment M90,
   wherein the automatic optimization procedure comprises adjusting the time difference t_{delay} and adjusting the time difference t_{delay}′.
M92. The method according to any of the preceding embodiments, with the features of embodiment M91,
   wherein the method comprises carrying out the adjusting by iterating the adjusting, and wherein the iterating is performed until the number of detectable peaks or detectable compounds in an obtained chromatogram is maximized.
M93. The method according to any of the preceding embodiments, with the features of embodiment M91,
   wherein the method comprises comparing the number of detectable peaks or detectable compounds in the obtained chromatogram to the number of detectable peaks or detectable compounds in the reference chromatogram.
M94. The method according to any of the preceding embodiments, with the features of embodiment M85,
   wherein the method comprises comparing the number of detectable peaks or detectable compounds in an obtained chromatogram to the number of detectable peaks or detectable compounds in a reference chromatogram,
   wherein this reference chromatogram is provided externally.
M95. The method according to any of the preceding embodiments, with the features of embodiments M92, M93 and M94,
   wherein the detectable peaks or compounds correspond to peptides, proteins, and/or other biomolecules.
M96. The method according to any of the preceding embodiments, with the features of embodiment M91,
   wherein the method comprises carrying out the adjusting by iterating the adjusting, and
   wherein the iterating is performed by comparing the peaks in an obtained chromatogram with the peaks in the reference chromatogram until the match with the reference chromatogram is maximized.
M97. The method according to any of the preceding embodiments, with the features of embodiment M91,
   wherein the method comprises carrying out the adjusting by iterating the adjusting, and
   wherein the iterating is performed by comparing the peaks in an obtained chromatogram with the peaks in the reference chromatogram until the match with the reference chromatogram is maximized, and
   wherein this reference chromatogram is provided externally.
M98. The method according to any of the preceding embodiments, with the features of embodiment M91,
   wherein the method comprises carrying out the adjusting by iterating the adjusting, and
   wherein iterating is performed at least in part until the number of detectable peaks or detectable compounds in an obtained chromatogram is maximized and at least in part by comparing the peaks in an obtained chromatogram with the peaks in the reference chromatogram until the match with the reference chromatogram is maximized.
M99. The method according to any of the preceding embodiments, with the features of embodiment M91,
   wherein the method comprises carrying out the adjusting by iterating the adjusting, and
   wherein iterating is performed at least in part until the number of detectable peaks or detectable compounds in an obtained chromatogram is maximized and at least in part by comparing the peaks in an obtained chromatogram with the peaks in a reference chromatogram until the match with this reference chromatogram is maximized, and wherein this reference chromatogram is provided externally.
M100. The method according to any of the preceding embodiments, with the features of any of the embodiments M92 to M99,
   wherein the method comprises making use of threshold peak detection algorithms in the detection and/or the comparison of peaks.
M101. The method according to any of the preceding embodiments, with the features of embodiment M100,
   wherein the method comprises using a threshold peak detection based on peak height or signal height.
M102. The method according to any of the preceding embodiments, with the features of embodiment M100,
   wherein the method comprises using a threshold peak detection based on peak area or signal area.
M103. The method according to any of the preceding embodiments, with the features of embodiment M100,
   wherein the method comprises using a threshold peak detection based on peak detection algorithms used in coding sequence.
M104. The method according to any of the preceding embodiments, with the features of embodiment M100,
   wherein the method comprises using threshold peak detection algorithms comprising machine-learning techniques.
M105. The method according to any of the preceding embodiments, with the features of embodiment M86,
   wherein the optimization procedure comprises utilizing at least in part a manual optimization procedure.
M106. The method according to any of the preceding embodiments, with the features of embodiment M105,
   wherein the step of acquiring a reference chromatogram precedes the step of utilizing at least in part the manual optimization procedure.
M107. The method according to any of the preceding embodiments, with the features of embodiment M105,
   wherein the manual optimization procedure comprises:
   manually defining a detection-window by a user, wherein the detection window comprises a time from the start of detection to the end of detection,
   manually defining a first and a last eluted compounds that should be present in an optimized chromatogram by the user,
   wherein the optimized chromatogram comprises an obtained chromatogram at the end of the optimization procedure.
M108. The method according to any of the preceding embodiments, with the features of embodiment M107,
   wherein the definition of the detection-window by the user comprises manually cropping a portion of interest of an obtained chromatogram,
   wherein the defined detection-window underlies the portion of interest of the obtained chromatogram, and
   wherein the cropping is performed on a dedicated user interface.
M109. The method according to any of the preceding embodiments, with the features of embodiment M107,
   wherein a mass spectrometer and/or a diode array detector and/or another peak detection instrument is used in defining the first and the last eluted compounds that are present in the optimized chromatogram by the user.
M110. The method according to any of the preceding embodiments, with the features of embodiment M107,
   wherein the manual optimization procedure comprises manually adjusting the time difference t_{delay} and the time difference t_{delay}′ by the user, and
   wherein the controller automatically optimizes the rest of a workflow.
M111. The method according to any of the preceding embodiments, with the features of embodiment M107,
   wherein the manual optimization procedure comprises manually adjusting the time difference t_{delay} and the time difference t_{delay}′ by the user,
   and wherein the user manually adjusts the rest of a workflow.
M112. The method according to any of the preceding embodiments, wherein the flow from the first separation column towards the detector in the first configuration (I) has a flow rate in the range of 0 to 10 mL/min, preferably 0 to 100 μL/min, such as 0.1 to 10 μL/min.
M113. The method according to any of the preceding embodiments with the features of embodiment M2, wherein the flow from the second separation column towards the waste has a flow rate in the range of 0 to 10 ml/min, preferably 0 to 100 μL/min, such as 0.1 to 10 μL/min.
M114. The method according to any of the preceding embodiments, wherein in the first configuration (I), a pressure provided by the separation pump is in the range of 100 bar to 2,000 bar, preferably 200 bar to 1,500 bar, such as 500 bar to 1,500 bar.
M115. The method according to any of the preceding embodiments, wherein the method comprises optimizing a solvent delivery.
M116. The method according to the preceding embodiment, wherein optimizing the solvent delivery comprises optimizing a solvent composition at a start of a gradient delivery.
M117. The method according to any of the 2 preceding embodiments, wherein optimizing the solvent delivery comprises optimizing a solvent composition at an end of a gradient delivery.
M118. The method according to any of the 3 preceding embodiments, wherein optimizing the solvent delivery comprises optimizing a slope of a gradient delivery.

Below, reference will be made to system embodiments. These embodiments are abbreviated by the letter “S” followed by a number. Whenever reference is herein made to “system embodiments”, these embodiments are meant.
S1. A system for liquid chromatography, the system comprising:
   a first separation column,
   a separation pump, and
   a detector,
   wherein the first separation column is configured to be fluidly connected to the separation pump and the detector in a first configuration (I),
   wherein the system is configured to supply a flow from the first separation column towards the detector by means of the separation pump in the first configuration (I), and
   wherein the system is configured to switch the system from the first configuration (I) to a second configuration (II),
   wherein the first separation column is configured to be fluidly connected to the second pump and to the detector in the second configuration (II), and
   wherein the system is configured to supply a flow from the first separation column towards the detector by means of the second pump in the second configuration (II).
S2. The system according to the preceding system embodiment,
   wherein the system further comprises:
   a second separation column, and
   a waste,
   wherein the second separation column is configured to be fluidly connected to the second pump and to the waste in the first configuration (I),
   wherein the system is configured to supply a flow from the second separation column towards the waste by means of the second pump in the first configuration (I).
S3. The system according to the preceding system embodiment,
   wherein the second separation column is configured to be fluidly connected to the separation pump and to the waste in the second configuration (II),
   wherein the system is configured to supply a flow from the second separation column towards the waste by means of the separation pump in the second configuration (II).
S4. The system according to any of the preceding system embodiments,
   wherein the system is configured to switch the system from the second configuration (II) to a third configuration (III), wherein the first separation column configured to be fluidly connected to the second pump and to a waste, and wherein the system is configured to supply a flow from the first separation column towards the waste by means of the second pump in the third configuration (III).
S5. The system according to the preceding system embodiment,
   wherein in the third configuration (III) the second separation column is configured to be fluidly connected to the separation pump and to the detector, wherein the system is further configured to supply a flow from the second separation column towards the detector by means of the separation pump in the third configuration (III).
S6. The system according to any of the preceding system embodiments,
   wherein the system is configured to switch the system from the first configuration (I) to the second configuration (II) at a first switching time (T_{II}).
S7. The system according to any of the preceding system embodiments, with the features of embodiment S4,
   wherein the system is configured to switch the system from the second configuration (II) to the third configuration at a second switching time (T_{III}), wherein the second switching time (T_{III}) is later than the first switching time (T_{II}).
S8. The system according to the preceding system embodiment,
   wherein a time difference t_{delay} between the second switching time (T_{III}) and the first switching time (T_{II}) is based on a volume V₅ of the second separation column, on a volume V_{con} of fluidic connections connected to the second separation column, and on a flow rate F of the separation pump.
S9. The system according to the preceding system embodiment,
   wherein the time difference t_{delay} fulfills the following equation:

t_{delay}=(V₅+V_{con})/F.
S10. The system according to any of the preceding system embodiments, with the features of embodiment S7,
   wherein the time difference t_{delay} amounts to between 0 minutes and 100 minutes, preferably between 1 minute and 20 minutes, more preferably between 1 minute and 10 minutes.
S11. The system according to any of the preceding system embodiments, with the features of embodiment S6,
   wherein at the first switching time (T_{II}), a flow rate F′ of the second pump is substantially equal to the flow rate F of the separation pump.
S12. The system according to any of the preceding system embodiments, with the features of embodiment S4,
   wherein a flow rate F′ of the second pump in the third configuration (III) is substantially larger than the flow rate F of the separation pump in the third configuration (III).
S13. The system according to any of the preceding system embodiments, with the features of embodiment S4, wherein the system is configured to switch the system from the third configuration (III) to a fourth configuration (IV), wherein the first separation column is fluidly connected to the separation pump and to a waste, and wherein the system is configured to supply a flow from the first separation column towards the waste by means of the separation pump in the fourth configuration (IV).
S14. The system according to the preceding system embodiment,
   wherein in the fourth configuration (IV), the second separation column is fluidly connected to the second pump and to the detector, and wherein the system is configured to supply a flow from the second separation column towards the detector by means of the second pump in the fourth configuration (IV).
S15. The system according to any of the preceding system embodiments, with the features of embodiment S13,
   wherein the system is configured to switch the system from the third configuration
   (III) to the fourth configuration (IV) at a third switching time (T_{IV}), wherein the third switching time (T_{IV}) is later than the second switching time (T_{III}).
S16. The system according to any of the preceding system embodiments, with the features of embodiment S13,
   wherein system is configured to switch the system from the fourth configuration (IV) back to the first configuration (I) at a fourth switching time (T_{I}), thereby forming a cyclic process and thereby ending a previous cycle and thereby starting a subsequent cycle,
   wherein the fourth switching time (T_{I}) is later than the third switching time (T_{IV}) and wherein a time difference t_{delay}′ between the fourth switching time (T_{I}) and the third switching time (T_{IV}) is based on a volume V₈′ of the first separation column, on a volume V_{con}′ of fluidic connections connected to the first separation column, and on a flow rate F of the separation pump.
S17. The system according to the preceding system embodiment,
   wherein the time difference t_{delay}′ fulfills the following equation:

t_{delay}′=(V₈′+V_{con}′)/F.
S18. The system according to any of the preceding system embodiments, with the features of embodiment S15,
   wherein at the third switching time (T_{IV}), the flow rate F′ of the second pump is substantially equal to the flow rate of the separation pump.
S19. The system according to any of the preceding system embodiments, with the features of embodiment S16,
   wherein the flow rate F′ of the second pump in the first configuration (I) is substantially larger than the flow rate F of the separation pump in the first configuration (I).
S20. The system according to any of the preceding system embodiments, with the features of embodiment S16,
   wherein the time difference t_{delay}′ amounts to between 0 minutes and 100 minutes, preferably between 1 minute and 20 minutes, more preferably between 1 minute and 10 minutes.
S21. The system according to any of the preceding system embodiments, with the features of embodiment S16,
   wherein the time difference t_{delay}′ substantially coincides with the time difference t_{delay}.
S22. The system according to any of the preceding system embodiments, with the features of embodiment S16,
   wherein the volume V₈′ of the first separation column substantially coincides with the volume V₅ of the second separation column.
S23. The system according to any of the preceding system embodiments, with the features of embodiment S16,
   wherein the volume V_{con}′ of fluidic connections connected to the first separation column substantially coincides with the volume V_{con} of fluidic connections connected to the second separation column.
S24. The system according to any of the preceding system embodiments, with the features of embodiment S16,
   wherein the system, after the fourth switching time T_{I}, is configured to switch the system back to the second configuration at a subsequent first switching time T_{II}′, wherein the subsequent first switching time T_{II}′ is later than the fourth switching time T_{I}, and
   wherein the time difference between the subsequent first switching time T_{II}′ r and the fourth switching time T_{I} is equal to t_{delay}.
S25. The system according the preceding system embodiment,
   wherein the subsequent cycle follows the same temporal sequence such that times T_{II}′, T_{III}′, T_{IV}′, T_{I}′ of the subsequent cycle correspond, respectively, to the times T_{II}, T_{III}, T_{IV}, T_{I} of the previous cycle.
S26. The system according to any of the preceding system embodiments, the system comprises a controller,
   wherein the system is configured to switch the system from the first configuration (I) to the second configuration (II) by means of the controller.
S27. The system according to any of the preceding system embodiments, with the features of embodiment S4,
   wherein the system is configured to switch the system from the second configuration (II) to the third configuration (III) by means of the controller.
S28. The system according to any of the preceding system embodiments, with the features of embodiment S13 and S26,
   wherein the system is configured to switch the system from the third configuration (III) to the fourth configuration (IV) by means of the controller.
S29. The system according to any of the preceding system embodiments, with the features of embodiment S13 and S26,
   wherein the system is configured to switch the system from the fourth configuration (IV) to the first configuration (I) by means of the controller.
S30. The system according to any of the preceding system embodiments, with the features of embodiment S7 and S11 and S26,
   wherein the system is configured to control the flow rate F of the first pump and the flow rate F′ of the second pump are controlled by the controller.
S31. The system according to any of the preceding system embodiments,
   wherein the liquid chromatography system comprises a pre-column switching valve,
   wherein the pre-column switching valve comprises a plurality of ports and a plurality of connecting elements for interchangeably connecting the ports,
   wherein
      one port of the pre-column switching valve is fluidly connected to the separation pump,
      one port of the pre-column switching valve is fluidly connected to the second pump,
      one port of the pre-column switching valve is fluidly connected to the first separation column,
      one port of the pre-column switching valve is fluidly connected to the second separation column.
S32. The system according the preceding system embodiment,
   wherein in the first configuration (I), the port of the pre-column switching valve, which is fluidly connected to the separation pump, is connected to the port of the pre-column switching valve, which is fluidly connected to the first separation column, and
   wherein in the first configuration (I), the port of the pre-column switching valve, which is fluidly connected to the second pump, is fluidly connected to the port of the pre-column switching valve, which is fluidly connected to the second separation column.
S33. The system according to any of the preceding system embodiments, with the features of embodiment S31,
   wherein in the second configuration (II), the port of the pre-column switching valve, which is fluidly connected to the separation pump, is fluidly connected to the port of the pre-column switching valve, which is fluidly connected to the second separation column, and wherein in the second configuration (II), the port of the pre-column switching valve, which is fluidly connected to the second pump, is fluidly connected to the port of the pre-column switching valve, which is fluidly connected to the first separation column.
S34. The system according to any of the preceding system embodiments, with the features of embodiment S6 and S31,
   wherein the system is configured to switch the system, via the pre-column switching valve, from the first configuration (I) to the second configuration (II) at the first switching time T_{II}
S35. The system according to any of the preceding system embodiments, with the features of embodiment S24 and S31,
   wherein the system is configured to switch the system, via the pre-column switching valve, from the first configuration (I) to the second configuration (II) at the subsequent first switching time T_{II}′ in the subsequent cycle.
S36. The system according to any of the preceding system embodiments, with the features of embodiment S24 and S4,
   wherein in the third configuration (III), the port of the pre-column switching valve, which is fluidly connected to the separation pump, is fluidly connected to the port of the pre-column switching valve, which is fluidly connected to the second separation column, and
   wherein in the third configuration (III), the port of the pre-column switching valve, which is fluidly connected to the second pump, is fluidly connected to the port of the pre-column switching valve, which is fluidly connected to the first separation column, in the third configuration (III).
S37. The system according to any of the preceding system embodiments, with the features of embodiment S13 and S31,
   wherein in the fourth configuration (IV), the port of the pre-column switching valve, which is fluidly connected to the separation pump, is fluidly connected to the port of the pre-column switching valve, which is fluidly connected to the first separation column, and
   wherein in the fourth configuration (IV), the port of the pre-column switching valve, which is fluidly connected to the second pump, is fluidly connected to the port of the pre-column switching valve, which is fluidly connected to the second separation column.
S38. The system according to any of the preceding system embodiments, with the features of embodiment S16 and S31,
   wherein the system is configured to switch the system, via the pre-column switching valve, from the third configuration (III) to the fourth configuration (IV) at the third switching time T_{IV}.
S39. The system according to any of the preceding system embodiments, with the features of embodiment S25 and S31,
   wherein the system is configured to switch the system, via the pre-column switching valve, from the third configuration (III) to the fourth configuration (III) at the subsequent third switching time T_{IV}′ in the subsequent cycle.
S40. The system according to any of the preceding system embodiments, with the features of embodiment S26, S34 and S35,
   wherein the system is configured to control the switching of via the pre-column switching valve from the first configuration (I) to the second configuration (II) by the controller.
S41. The system according to any of the preceding system embodiments, with the features of embodiment S26, S38 and S39,
   wherein the system is configured to control the switching of the system, via the pre-column switching valve, from the third configuration (III) to the fourth configuration (IV) by the controller.
S42. The system according to any of the preceding system embodiments,
   wherein the system comprises a post-column switching valve,
   wherein the post-column switching valve comprises a plurality of ports and a plurality of connecting elements for interchangeably connecting the ports,
   wherein
      one port of the post-column switching valve is fluidly connected to the first separation column,
      one port of the post-column switching valve is fluidly connected to the second separation column,
      one port of the post-column switching valve is fluidly connected to the waste,
      one port of the post-column switching valve is fluidly connected to the detector.
S43. The system according to the preceding system embodiment,
   wherein in the first configuration (I), the port of the post-column switching valve, which is fluidly connected to the first separation column, is fluidly connected to the port of the post-column switching valve, which is fluidly connected to the detector, and
   wherein in the first configuration (I), the port of the post-column switching valve, which is fluidly connected to the second separation column, is fluidly connected to the port of the post-column switching valve, which is fluidly connected to the waste
S44. The system according to any of the preceding system embodiments, with the features of embodiment S42,
   wherein in the second configuration (II), the port of the post-column switching valve, which is fluidly connected to the first separation column, is fluidly connected to the port of the post-column switching valve, which is fluidly connected to the detector, and
   wherein in the second configuration (II), the port of the post-column switching valve, which is fluidly connected to the second separation column, is fluidly connected to the port of the post-column switching valve, which is fluidly connected to the waste.
S45. The system according to any of the preceding system embodiments, with the features of embodiment S4 and S42,
   wherein in the third configuration (III), the port of the post-column switching valve, which is fluidly connected to the first separation column, is fluidly connected to the port of the post-column switching valve, which is fluidly connected to a waste, and
   wherein in the third configuration (III), the port of the post-column switching valve, which is fluidly connected to the second separation column, is fluidly connected to the port of the post-column switching valve, which is fluidly connected to the detector.
S46. The system according to any of the preceding system embodiments, with the features of embodiment S4 and S42,
   wherein the system is configured to switch the system, via the post-column switching valve, from the second configuration (II) to the third configuration (III) at the second switching time T_{III}.
S47. The system according to any of the preceding system embodiments, with the features of embodiment S25 and S42,
   wherein the system is configured to switch the system via the post-column switching valve from the second configuration (II) to the third configuration (III) at the subsequent second switching time T_{II}′ r′ in the subsequent cycle.
S48. The system according to any of the preceding system embodiments, with the features of embodiment S13 and S42,
   wherein in the fourth configuration (IV), the port of the post-column switching valve, which is fluidly connected to the first separation column, is fluidly connected to the port of the post-column switching valve, which is fluidly connected to a waste, in the fourth configuration (IV), and
   wherein in the fourth configuration (IV), the port of the post-column switching valve, which is fluidly connected to the second separation column, is fluidly connected to the port of the post-column switching valve, which is fluidly connected to the detector.
S49. The system according to any of the preceding embodiments, with the features of embodiments S17 and S42,
   wherein the system is configured to switch the system, via the post-column switching valve, from the fourth configuration (IV) to the first configuration (I) at the fourth switching time T_{I}.
S50. The system according to any of the preceding embodiments, with the features of embodiments S25 and S42,
   wherein the system is configured to switch the system, via the post-column switching valve, from the fourth configuration (IV) to the first configuration (I) at the subsequent fourth switching time T_{I}′ in the subsequent cycle.
S51. The system according to any of the preceding embodiments, with the features of embodiments S4, S26 and S42,
   wherein the system is configured to switch the system, via the post-column switching valve, from the second configuration (II) to the third configuration (III) is controlled by the controller.
S52. The system according to any of the preceding embodiments, with the features of embodiments S13, S26 and S42,
   wherein the system is configured to control the switching, via the post-column switching valve, from the fourth configuration (IV) to the first configuration (I) by the controller.
S53. The system according to any of the system embodiments from S1 to S41 with the features of embodiment S2,
   wherein the system comprises a double barrel electrospray source, and
   wherein the double barrel electrospray source comprises a first barrel comprising the first separation column and a second barrel comprising the second separation column.
S54. The system according to the preceding system embodiment,
   wherein a terminal section of the first barrel comprises a first emitter, the first emitter being configured to spray into the detector, and
   wherein a terminal section of the second barrel comprises a second emitter, the second emitter being configured to spray into the detector.
S55. The system according to any the 2 preceding system embodiment,
   wherein the detector comprises a mass spectrometry detector.
S56. The system according to any of the preceding 3 system embodiments,
   wherein the system is configured to enable the first barrel to spray from the first emitter into the detector in the first configuration (I) by applying a high voltage to the first barrel in the first configuration (I).
S57. The system according to of any of the preceding system embodiments with the features of embodiments S54 and S55,
   wherein the system is configured to enable the first barrel to spray from the first emitter into the detector in the second configuration (II) by applying a high voltage to the first barrel in the second configuration (II).
S58. The system according to any of the preceding system embodiments with the features of embodiments S7, S54 and S55,
   wherein the system is configured to enable the second barrel to spray from the second emitter into the detector in the third configuration (III) by applying a high voltage to the second barrel in the third configuration (III).
S59. The system according to any of the preceding system embodiments with the features of embodiments S13, S54 and S55,
   wherein the system is configured to enable the second barrel to spray from the second emitter into the detector in the fourth configuration (IV) by applying a high voltage to the second barrel in the fourth configuration (IV).
S60. The system according to the preceding 4 system embodiments, wherein the high voltage is in a range between 1 kV and 5 kV.
S61. The system according to any of the preceding system embodiments with the features of embodiments S57 and S58,
   wherein the system is configured to switch system from the second configuration (II) to the third configuration (III) at the second switching time T_{III},
   by means of switching from enabling the first barrel to spray from the first emitter into the detector to enabling the second barrel to spray from the second emitter into the detector.
S62. The system according to any of the preceding system embodiments with the features of embodiments S57, S58 and S25,
   wherein the system is configured to switch system from the second configuration (II) to the third configuration (III) at the subsequent second switching time T_{III}′ in the subsequent cycle,
   by means of switching from enabling the first barrel to spray from the first emitter into the detector to enabling the second barrel to spray from the second emitter into the detector.
S63. The system according to any of the preceding system embodiments with the features of the embodiments S56 and S59,
   wherein the system is configured to switch system from the fourth configuration (IV) to the first configuration (I) at the fourth switching time (T_{I}),
   by means of switching from enabling the second barrel to spray from the second emitter into the detector to enabling the first barrel to spray from the first emitter into the detector.
S64. The system according to any of the preceding system embodiments with the features of the embodiments S56, S59 and S25,
   wherein the system is configured to switch system from the fourth configuration (IV) to the first configuration (I) at the subsequent fourth switching time T_{I}′ in the subsequent cycle,
   by means of switching from enabling the second barrel to spray from the second emitter into the detector to enabling the first barrel to spray from the first emitter into the detector.
S65. The system according to any of the system preceding embodiments,
   wherein the system comprises an injection valve,
   wherein the injection valve comprises a plurality of ports and a plurality of connecting elements,
   and wherein
      one port of the injection valve is fluidly connected to the second pump,
      one port of the injection valve is fluidly connected to a port of the precolumn-switching valve,
   wherein the system is configured to
      fluidly connect the port of the injection valve, which is fluidly connected to the second pump, to the port of the injection valve, which is fluidly connected the precolumn-switching valve.
S66. The system according to the preceding system embodiment,
   wherein the injection valve further comprises another plurality of ports, and
   wherein the system may be configured to fluidly connect the other plurality of ports to a plurality of sample reservoirs containing a plurality of samples.
S67. The system according to any of the preceding system embodiments, with the features of embodiment S65,
   wherein the system is configured to inject, by means of the injection valve, a sample from a sample reservoir into the liquid chromatography system.
S68. The system according to any of the preceding system embodiments, with the features of embodiment S67,
   wherein the system is configured to create a flow of a sample from the injection valve towards the pre-column switching valve by means of the second pump.
S69. The system according to any of the preceding system embodiments, with the features of embodiment S67,
   wherein the system is configured to switch from injecting a sample from a sample reservoir, by means of the injection valve, into the system to injecting another sample from another sample reservoir, by means of the injection valve, into the system.
S70. The system according to any of the preceding system embodiments, with the features of embodiments S7 and S67,
   wherein the switching from injecting a sample from a sample reservoir, by means of the injection valve, into the system
   to injecting another sample from another sample reservoir, by means of the injection valve, into the liquid chromatography system
   happens at the first switching time (T_{II}).
S71. The system according to any of the preceding system embodiments, with the features of embodiments S25 and S67,
   wherein the switching from injecting a sample from a sample reservoir, by means of the injection valve, into the system
   to injecting another sample from another sample reservoir, by means of the injection valve, into the liquid chromatography system
   happens at the subsequent first switching time (T_{II}′) in the subsequent cycle.
S72. The system according to any of the preceding system embodiments, with the features of embodiments S4 and S67,
   wherein the switching from injecting a sample from a sample reservoir, by means of the injection valve, into the system
   to injecting another sample from another sample reservoir, by means of the injection valve, into the liquid chromatography system
   happens at the third switching time (T_{IV}).
S73. The system according to any of the preceding system embodiments, with the features of embodiments S25 and S67,
   wherein the switching from injecting a sample from a sample reservoir, by means of the injection valve, into the system
   to injecting another sample from another sample reservoir, by means of the injection valve, into the liquid chromatography system
   happens at the subsequent third switching time (T_{IV}′) in the subsequent cycle.
S74. The system according to any of the preceding system embodiments, with the features of embodiments S26,
   wherein the system is configured to control the injection, by means of the injection valve, of a sample from a sample reservoir into the system by the controller, and
   wherein the system is configured to control the switching from injecting a sample from a sample reservoir, by means of the injection valve, into the system
   to injecting another sample from another sample reservoir by means of the injection valve into the system by the controller.
S75. The system according to any of the preceding system embodiments, with the features of embodiments S7, S15 and S16,
   wherein the system is configured to start the provision of a gradient, by the separation pump, at the first switching time (T_{II}),
   wherein the system is configured to stop the provision of a gradient, by the separation pump, at a time T_{grad. stop},
   wherein the time T_{grad. stop} is later than the second switching time T_{III}, and
   wherein the time T_{grad. stop} is earlier than the third switching time T_{IV}.
S76. The system according to any of the preceding system embodiments, with the features of embodiment S25,
   wherein the system is configured to start the provision of a gradient, by the separation pump, at the third switching time (T_{IV}),
   wherein the system is configured to stop the provision of a gradient, by the separation pump, at a time T_{grad. stop}′,
   wherein the time T_{grad. stop}′ is later than the fourth switching time T_{II}, and
   wherein the time T_{grad. stop}′ is earlier than the subsequent first switching time T_{II}′ in the subsequent cycle.
S77. The system according to any of the preceding system embodiments, with the features of embodiment S26,
   wherein the system is configured to control the start of the provision of the gradient and the stop of the provision of the gradient by the controller.
S78. The system according to any of the preceding system embodiments, with the features of embodiment S6,
   wherein at the first switching time (T_{II}), a solvent composition delivered by the second pump is substantially identical to a solvent composition delivered by the separation pump.
S79. The system according to any of the preceding system embodiments, with the features of embodiment S15,
   wherein at the third switching time (T_{IV}), a solvent composition delivered by the second pump is substantially identical to a solvent composition delivered by the separation pump.
S80. The system according to any of the preceding system embodiments, with the features of embodiments S7 and S16,
   wherein the system is configured to start the detection, by means of a detector, at the second switching time (T_{III}),
   wherein the system is configured to stop the detection, by means of the detector, at a detector stop time T_{dect. stop},
   wherein the detector stop time T_{dect. stop} is later than the third switching time T_{IV},
   wherein the detector stop time T_{dect. stop} is earlier than the fourth switching time T_{I}.
S81. The system according to any of the preceding system embodiments, with the features of embodiment S25,
   wherein the system is configured to start the detection, by means of the detector, at the fourth switching time T_{I},
   wherein the system is configured to stop the detection, by means of the detector, at a further detector stop time T_{dect. stop}′,
   wherein the time further detector stop time T_{dect. stop}′ is later than the subsequent first switching time T_{II}′ r in the subsequent cycle,
   wherein the further detector stop time T_{dect. stop}′ is earlier than the subsequent second switching time T_{III} in the subsequent cycle.
S82. The system according to any of the preceding system embodiments, with the features of embodiment S26,
   wherein the system is configured to control the start of the detection and the stop of the detection may be controlled by the controller.
S83. The system according to any of the preceding system embodiments,
   wherein the system is configured to utilize an optimization procedure to optimize the time difference t_{delay} and/or the time difference t_{delay}′.
S84. The system according to any of the preceding system embodiments, with the features of embodiments S26 and S83,
   wherein the system is configured to control the steps comprised in the optimization procedure at least in part by the controller.
S85. The system according to any of the preceding system embodiments, wherein the system comprises a user interface.
S86. The system according to any of the preceding system embodiments, with the features of embodiment S83 and S85,
   wherein the system is configured to use the user interface, at least in part, in the steps of the optimization procedure.
S87. The system according to any of the preceding system embodiments, with the features of embodiment S83,
   wherein the system is configured to acquire a reference chromatogram.
S88. The system according to any of the preceding system embodiments, with the features of embodiment S83,
   wherein the system is configured to acquire a reference chromatogram containing at least some of the characteristic chromatographic peaks of a sample.
S89. The system according to any of the preceding system embodiments, with the features of embodiment S83,
   wherein the system is configured to acquire the reference by performing a linear gradient elution followed by an isocratic phase.
S90. The system according to any of the preceding system embodiments, with the features of embodiment S83,
   wherein the optimization procedure comprises carrying out an automatic optimization procedure,
   wherein the system is configured to carry out the automatic optimization procedure.
S91. The system according to any of the preceding system embodiments, with the features of embodiments S87 and S90,
   wherein the system is configured to perform the step of acquiring a reference chromatogram before the step of carrying out the automatic optimization procedure.
S92. The system according to the preceding system embodiment,
   wherein the automatic optimization procedure comprises adjusting the time difference t delay and adjusting the time difference t_{delay}′,
   wherein the system is configured to perform the adjusting of the time difference t_{delay} and the adjusting of the time difference t_{delay}′
S93. The system according to the preceding system embodiment,
   wherein the system is configured to carry out the adjusting by iterating the adjusting, and
   wherein the system is configured to perform the iterating until the number of detectable peaks or detectable compounds in an obtained chromatogram is maximized.
S94. The system according to any of the preceding system embodiments, with the features of embodiment S92,
   wherein the system is configured to compare the number of detectable peaks or detectable compounds in the obtained chromatogram to the number of detectable peaks or detectable compounds in the reference chromatogram.
S95. The system according to any of the preceding system embodiments, with the features of embodiment S86,
   wherein the system is configured to compare the number of detectable peaks or detectable compounds in an obtained chromatogram to the number of detectable peaks or detectable compounds in a reference chromatogram,
   wherein this reference chromatogram is provided externally.
S96. The system according to any of the preceding three system embodiments,
   wherein the detectable peaks or compounds correspond to peptides, proteins, and/or other biomolecules.
S97. The system according to any of the preceding system embodiments, with the features of embodiment S92,
   wherein the system is configured to carry out the adjusting by iterating the adjusting, and
   wherein the system is configured to perform the iterating by comparing the peaks in an obtained chromatogram with the peaks in the reference chromatogram until the match with the reference chromatogram is maximized.
S98. The system according to any of the preceding system embodiments, with the features of embodiment S92,
   wherein the system is configured to carry out the adjusting by iterating the adjusting, and
   wherein the system is configured to perform the iterating by comparing the peaks in an obtained chromatogram with the peaks in the reference chromatogram until the match with the reference chromatogram is maximized, and
   wherein this reference chromatogram is provided externally.
S99. The system according to any of the preceding system embodiments, with the features of embodiment S92,
   wherein the system is configured to carry out the adjusting by iterating the adjusting, and
   wherein the system is configured to perform the iterating at least in part until the number of detectable peaks or detectable compounds in an obtained chromatogram is maximized and at least in part by comparing the peaks in an obtained chromatogram with the peaks in the reference chromatogram until the match with the reference chromatogram is maximized.
S100. The system according to any of the preceding system embodiments, with the features of embodiment S92,
   wherein the system is configured to carry out the adjusting by iterating the adjusting, and
   wherein the system is configured to perform the iterating at least in part until the number of detectable peaks or detectable compounds in an obtained chromatogram is maximized and at least in part by comparing the peaks in an obtained chromatogram with the peaks in a reference chromatogram until the match with this reference chromatogram is maximized, and
   wherein this reference chromatogram is provided externally.
S101. The system according to any of the preceding system embodiments, with the features of any of the embodiments S93 to S100,
   wherein the system is configured to make use of threshold peak detection algorithms in the detection and/or the comparison of peaks.
S102. The system according to the preceding system embodiment,
   wherein the system is configured to use a threshold peak detection based on peak height or signal height.
S103. The system according to any of the preceding system embodiments, with the features of embodiment S101,
   wherein the system is configured to use a threshold peak detection based on peak area or signal area.
S104. The system according to any of the preceding system embodiments, with the features of embodiment S101,
   wherein the system is configured to use a threshold peak detection based on peak detection algorithms used in coding sequence.
S105. The system according to any of the preceding system embodiments, with the features of embodiment S101,
   wherein the system is configured to use threshold peak detection algorithms comprising machine-learning techniques.
S106. The system according to any of the preceding system embodiments, with the features of embodiment S87,
   wherein the system is configured to perform the optimization procedure utilizing at least in part a manual optimization procedure.
S107. The system according to the preceding system embodiment,
   wherein the system is configured to perform the step of acquiring a reference chromatogram before the step of utilizing at least in part the manual optimization procedure.
S108. The system according to any of the preceding system embodiments, with the features of embodiment S106,
   wherein the system is configured to allow a manual optimization procedure comprising:
   manually defining a detection-window by a user, wherein the detection window comprises a time from the start of detection to the end of detection,
   manually defining a first and a last eluted compounds that should be present in an optimized chromatogram by the user,
   wherein the optimized chromatogram comprises an obtained chromatogram at the end of the optimization procedure.
S109. The system according to any of the preceding system embodiments, with the features of embodiment S85 and S108,
   wherein the system is configured to allow the definition of the detection-window by the user by manually cropping a portion of interest of an obtained chromatogram,
   wherein the defined detection-window underlies the portion of interest of the obtained chromatogram, and
   wherein the cropping is performed on a dedicated user interface.
S110. The system according to any of the preceding system embodiments, with the features of embodiment S108,
   wherein the system is configured to use a mass spectrometer and/or a diode array detector and/or another peak detection instrument in defining the first and the last eluted compounds that are present in the optimized chromatogram by the user.
S111. The system according to any of the preceding system embodiments, with the features of embodiment S108,
   wherein the system is configured to allow, in the manual optimization procedure, manually adjusting the time difference t_{delay} and the time difference t_{delay}′ by the user, and
   wherein the controller is configured to automatically optimize the rest of a workflow.
S112. The system according to any of the preceding system embodiments, with the features of embodiment S108,
   wherein the system is configured to allow, in the manual optimization procedure, manually adjusting the time difference t_{delay} and the time difference t_{delay}′ by the user,
   and wherein the system is further configured for the user to manually adjust the rest of a workflow.
S113. The system according to any of the preceding system embodiments, wherein the flow from the first separation column towards the detector in the first configuration (I) has a flow rate in the range of 0 to 10 mL/min, preferably 0 to 100 μL/min, such as 0.1 to 10 μL/min.
S114. The system according to any of the preceding system embodiments, with the features of embodiment S2, wherein the flow from the second separation column towards the waste has a flow rate in the range of 0 to 10 ml/min, preferably 0 to 100 μL/min, such as 0.1 to 10 μL/min.
S115. The system according to any of the preceding system embodiments, wherein in the first configuration (I), a pressure provided by the separation pump is in the range of 100 bar to 2,000 bar, preferably 200 bar to 1,500 bar, such as 500 bar to 1,500 bar.
S116. The system according to any of the preceding system embodiments, wherein the controller is configured to control the system to carry out the method according to any of the preceding method embodiments.
S117. The system according to any of the preceding system embodiments,
   wherein the system is adapted to carry out the method recited in any of the preceding method embodiments.
S118. The system according to any of the preceding system embodiments, wherein the system is adapted to carry out any given step of the method recited in any of the preceding method embodiments.
S119. The system according to any of the preceding system embodiments, wherein the system is configured to optimize a solvent delivery.
S120. The system according to the preceding embodiment, wherein optimizing the solvent delivery comprises optimizing a solvent composition at a start of a gradient delivery.
S121. The system according to the 2 preceding embodiments, wherein optimizing the solvent delivery comprises optimizing a solvent composition at an end of a gradient delivery.
S122. The system according to any of the 3 preceding embodiments, wherein optimizing the solvent delivery comprises optimizing a slope of a gradient delivery.

Below, reference will be made to use embodiments. These embodiments are abbreviated by the letter “U” followed by a number. Whenever reference is herein made to “use embodiments”, these embodiments are meant.
U1. The use of the liquid chromatography system in accordance with any of the preceding system embodiments for tandem liquid chromatography.
U2. The use according to the preceding embodiment, to carry out the method as recited in any of the preceding method embodiments.
U3. The use according to any of the preceding use embodiments,
   wherein the pre-column switching valve is used to switch the liquid chromatography system from the first configuration to the second configuration at the first switching time T_{II}
U4. The use according to any of the preceding use embodiments,
   wherein the post-column switching valve is used to switch the liquid chromatography system from the second configuration to the third configuration at the second switching time T_{III}.
U5. The use according to any of the preceding use embodiments,
   wherein the pre-column switching valve is used to switch the liquid chromatography system from the third configuration to the fourth configuration at the third switching time T_{IV}.
U6. The use according to any of the preceding use embodiments,
   wherein the post-column switching valve is used to switch the liquid chromatography system from the fourth configuration to the first configuration at the fourth switching time T_{I}.
U7. The use according to any of the preceding use embodiments,
   wherein the controller is used to automatically execute a workflow according to any of the preceding method embodiments.

Below, reference will be made to computer embodiments. These embodiments are abbreviated by the letter “C” followed by a number. Whenever reference is herein made to “computer embodiments”, these embodiments are meant.
C1. A computer program product comprising instructions which, when executed by a processor, cause the processor to control a system for liquid chromatography to carry out the method according to any of the preceding method embodiments.
C2. A computer-readable medium comprising instructions which, when executed by a processor, cause the processor to control a system for liquid chromatography to carry out the method according to any of the preceding method embodiments.
C3. A data carrier signal carrying the computer program product of embodiment C1.

### BRIEF DESCRIPTION OF THE FIGURES

FIG. 1 illustrates exemplary chromatograms of a liquid chromatography system for different values of the time difference between the start of gradient delivery and the start of detection in the liquid chromatography system.

FIG. 2 depicts, as an example, a preferred embodiment of a liquid chromatography system according to an embodiment of the present invention in a first configuration, which may be referred to as “first steady state”;

FIG. 3 depicts, as an example, a preferred embodiment of the system of FIG. 2 in a second configuration, which may be referred to as “first intermediate state”;

FIG. 4 depicts, as an example, a preferred embodiment of the system of FIG. 2 in a third configuration, which may be referred to as “second steady state”;

FIG. 5 depicts, as an example, a preferred embodiment of the system of FIG. 2 in a fourth configuration, which may be referred to as “second intermediate state”;

FIG. 6 depicts an exemplary visualization of a workflow of a tandem liquid chromatography system with an optimized acquisition time window based on four configurations of the tandem liquid chromatography system;

FIG. 7 illustrates, as an example, UV chromatograms of Cytochrome C showing the influence on UV chromatograms of Cytochrome C of the time difference between the start of detector acquisition and the start of gradient delivery in a liquid chromatography system.

FIG. 8 depicts, as an example, preferred embodiments of a liquid chromatography system utilizing a double barrel electrospray source and adopting four configurations according to embodiments of the present invention.

### DETAILED DESCRIPTION OF THE FIGURES

It is noted that not all the drawings carry all reference signs. Instead, in some of the drawings, some of the reference signs have been omitted for sake of brevity and simplicity of illustration.

Hereafter, exemplary embodiments of the present invention will be described in detail, referring to the accompanying figures.

While in the following preferred embodiments of the present invention will be described, the person skilled in the art will understand that the preferred embodiments are provided for illustrative purposes only and to render the disclosure of the present invention complete, and should by no means be construed to limit the scope of the present invention, which is defined by the claims.

From a very general viewpoint, embodiments of the present invention relate to executing a workflow in tandem a liquid chromatography (LC) system. Embodiments relate to executing a workflow in a tandem liquid chromatography system, characterized by the utilization of two pumps and two separation columns.

In order to perform LC, in general, a sample is subjected to flow, by means of the action of a pump, through a separation column and towards a detector. The pump that is utilized in a liquid chromatography system may deliver a gradient into the separation column. That it, the composition of the mobile phase over time may be changed using the separation pump. The mobile phase, moreover, may traverse the separation column in a given amount of time. Such amount of time may in turn depend on the volume of the separation column, as well as on the fluidic connection linking the separation column to the pump and the separation column to the detector. It may further depend on the flow rate of the pump. In other words, the gradient delivery at the separation pump at a given point in time may be different from the gradient delivery at the detector at the same given point. For example, right when the gradient starts being delivered by the pump, the gradient delivery at the pump is equal to the starting gradient delivery, while the gradient delivery at the detector will be equal to the starting gradient delivery at a later time.

In many prior art LC systems, the detector is configured to start the detection window as the pump starts delivering the gradient into the separation column. Such a workflow, however, hinders an optimized utilization of the detection window, since the detector is actively used beginning from when the pump starts delivering the gradient. In other words, the detector is actively used beginning from when the gradient delivery at the separation pump is the starting gradient and not when the gradient delivery at the detector is the starting gradient.

The present invention relates, at least in part, to a workflow, wherein the time difference between the start of gradient delivery and the start of detection is substantially different from zero, and may be optimized.

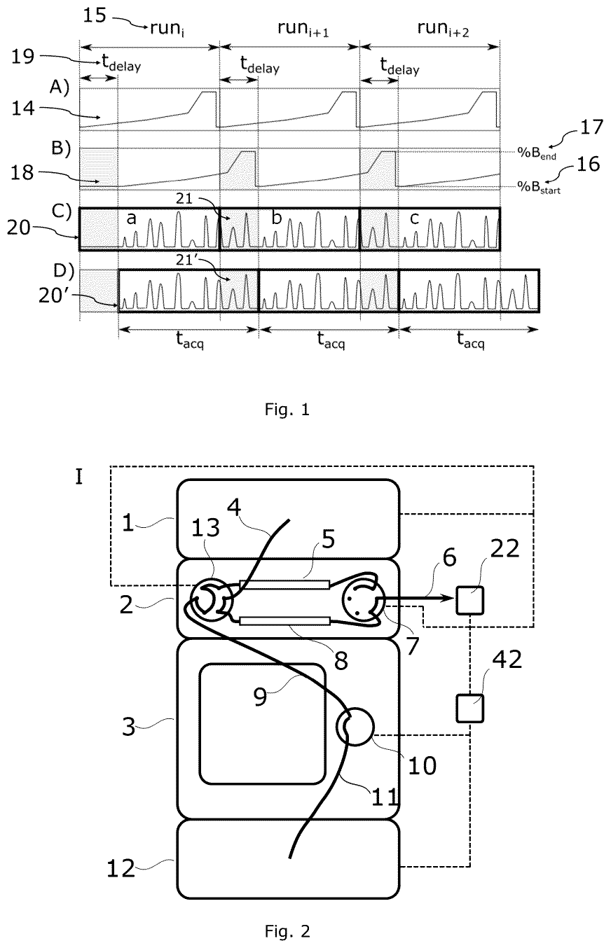

FIG. 1 illustrates exemplary chromatograms of a liquid chromatography system for different values of the time difference between the start of the gradient delivery and the start of the detection in the liquid chromatography system. Put differently, the effect the different values of said time difference is illustrated.

FIG. 1A) shows an exemplary periodic time variation of the gradient delivery at the pump 14. Generally, a pump may deliver a gradient in a liquid chromatography procedure. That is, the solvent composition may change over time. For example, different solvents A and B may be mixed at different ratios. FIG. 1A) (as FIG. 1 B)) depicts the volume % of solvent B in the solvent mixture over time. As depicted in FIG. 1A), the amount of solvent B increases monotonously with different rates, is then held constant and is then decreased again during run I (see item 15), but it will be understood that this is merely exemplary and that other solvent compositions over time may be used. The subsequent runs i+1 and i+2 have a corresponding solvent composition delivered over time. The start of the gradient delivery at the pump 14 may coincide, in this exemplary embodiment, with the start of the sample run 15. The gradient delivery at the pump 14 at the start of the sample run 15 may substantially coincide with the starting gradient delivery 16. Analogously, the gradient delivery at the pump 14 at the end of the sample run 15 may substantially coincide with the ending gradient delivery 17. The sample run 15 may be temporally followed by subsequent sample runs.

Generally, it should be understood that FIG. 1A) depicts the solvent composition at the pump, which may also be referred to as chromatographic pump or separation pump. Furthermore, it will be understood that the solvent composition at a detector downstream of the pump will be different to the solvent composition at the pump. In particular, there typically is a time lag or detail time t_{delay} between the two. Consider, for example, that the pump delivers with a flow rate of 10 μl/min and further consider that the fluidic path between the pump (e.g., connecting tubes, column, valves) have a total inner volume of 20 μl. In this example, it would take any change of solvent composition at the pump 2 min to arrive at the detector.

This is visible in FIG. 1 B). FIG. 1 B) depicts the solvent composition over time at the detector. In simple terms, this solvent composition corresponds to the solvent composition at the detector, but there is a time delay t_{delay} between the two. In other words, FIG. 1 B) shows an exemplary periodic time variation of the gradient delivery at the detector 18. It will be understood that the time difference t_{delay} 19 between the time at which the detector starts detecting and the time at which the gradient delivery starts at the pump 14 is usually different from zero.

FIG. 1 C) depicts exemplary chromatograms when not accounting for the delay time t_{delay}, i.e., in case that acquisition time windows 20 were chosen to coincide with the gradients runs (see 15) as delivered by the gradient pump. In this example, there are three acquisition time windows 20 a, 20 b, and 20 c, which coincide with the gradient delivery runs i, i+1, and i+2 at the pump. However, due to the time delay t_{delay}, the acquisition time windows are not ideal. In particular, there is a portion at the beginning of the first acquisition time window 20 a, where the gradient as delivered be the pump has not yet reached the detector. Furthermore, there is a portion 21 at the beginning of the second acquisition time window 20 b, where the gradient (and thus also sample) from the run i still arrives at the detector. That is, this portion 21 actually corresponds to the run i, but is (in the example discussed with reference to FIG. 1 C)) part of the data acquisition time window 20 a. It will be understood that similar considerations also apply to the data acquisition time window 20 c in FIG. 1 C).

FIG. 1 D) depicts exemplary chromatograms when the data acquisition time windows 20′ account for the delay time t_{delay}. It will be appreciated that the data acquisition time windows 20′ are shifted in the time domain with respect to the gradient runs 15 at the pump. Thus, the portion 21′ is correctly assigned to the first run. Furthermore, with regard to FIGS. 1 B) and 1 D), it will be appreciated that the data acquisition time windows correspond to the gradient as delivered at the detector.

Generally, in embodiments of the present invention, data acquisition time windows at the detector may be shifted with respect to analytical runs (or more specifically gradient runs) as delivered by the pump. This shift accounts for the time delay t_{delay}, i.e., the time it takes for the solvent to travel from the pump to the detector. It will be appreciated that better and more reproducible chromatograms are typically generated when taking the delay time into consideration by shifting the data acquisition time windows as described.

In tandem LC applications the workflows may be typically highly optimized for high throughput to obtain one chromatogram right after another. Therefore, the size/duration of the elution window may be consuming a significant portion of the duration of the gradient. Under these conditions, it may occur that the chromatogram may lack fractions of the compounds of interest. This is, for instance, illustrated in FIG. 1C. Additionally, it may occur that the resulting chromatogram is composed of compounds eluted partly from one separation column and partly from the other, which may not be intended as the chromatogram would not be strictly associated with a single sample run and even an individual sample. This is, for instance, illustrated in FIG. 1C. Hence, it may be advantageous to optimize t_{delay}.

It will be understood that embodiments of the herein presented approach allow to optimize the position of the elution window in the temporal domain, i.e., the period when compounds of interest are eluted from the separation column to achieve high sample throughput and uncompromised chromatographic performance. This may be realized by adjusting the start of the detector data acquisition relative to the start of the gradient as is illustrated in FIG. 1.

FIG. 2 depicts, as an example, a preferred embodiment of a liquid chromatography system according to an embodiment of the present invention in a first configuration I.

Embodiments of the present invention may be directed to utilizing a tandem liquid chromatography system, wherein two separation columns and two pumps are used. The liquid chromatography system, as illustrated in FIG. 2, may comprise a first separation column 8, a second separation column 5, a separation pump 1, a reconditioning pump 12 and a detector 22. The first separation column and the second separation column may be hosted in a column compartment 2. The system may comprise an autosampler 3, which may comprise an injection valve 10. The liquid chromatography system may further comprise a pre-column switching vale 13 and a post-column switching valve 7. The pre-column switching vale 13 and the post-column switching valve 7 may be hosted in the column compartment 2. The liquid chromatography system may comprise a waste.

Each of the injection valve 10, the pre-column switching valve 13 and the post-column switching valve 7 may comprise a stator, a rotor and a rotatable drive, respectively. Each stator may comprise a multitude of ports to which different elements in the liquid chromatography system may be fluidly connected to. Each rotor may comprise connecting elements, for example grooves, that may fluidly connect different ports of the stator. The rotor may be rotated relative to the stator using the rotatable drive, allowing the connecting elements of the rotor to establish fluidic connections between different ports of the stator.

One port of the injection valve 10 may have a fluidic connection 9 to one port of the pre-column switching valve 13. Another port of the injection valve 10 may have a fluidic connection 11 to the reconditioning pump 12. The port of the injection valve 10 which may have a fluidic connection 9 to one port of the pre-column switching valve 13, and the port of the injection valve 10 which may have a fluidic connection 11 to the reconditioning pump 12 may be fluidly connected by means of the connecting elements of the injection valve 10 in the configuration of FIG. 2. Furthermore, one port or a plurality of further ports of the injection valve 10 may have a fluidic connection to one or a plurality of sample reservoirs containing one or a plurality of samples.

One port of the pre-column switching valve 13 may have a fluidic connection 4 to the separation pump 1; another port of the pre-column switching valve 13 may have a fluidic connection to the first separation column 8; another port of the pre-column switching valve 13 may have a fluidic connection to the second separation column 5.

One port of the post-column switching valve 7 may have a fluidic connection 6 to the detector 22; another port of the post-column switching valve 7 may have a fluidic connection to the first separation column 8; another port of the post-column switching valve 7 may have a fluidic connection to the second separation column 5; another port of the post-column switching valve 7 may have a fluidic connection to a waste.

The configuration assumed by the pre-column switching valve 13 and by the post-column switching valve 7 may determine the fluidic connection between different elements of the chromatography system, or, in other words, the configuration of the liquid chromatography system. In particular, the configuration of the connecting elements of the pre-column switching valve 13 and of the post-column switching valve 7 determines the configuration of the liquid chromatography system.

As an example, in FIG. 2, an embodiment the liquid chromatography system is depicted, according to the present invention, in a first configuration I.

The port of the pre-column switching valve 13, which may have a fluidic connection to a port of the injection valve 10, and the port of the pre-column switching valve 13, which may have a fluidic connection to the second separation column 5, may be fluidly connected by means of the connecting elements of the pre-column switching valve 13 in the first configuration I. The port of the pre-column switching valve 13, which may have a fluidic connection to the separation pump 1, and the port of the pre-column switching valve 13, which may have a fluidic connection to the first separation column 8, may be fluidly connected by means of the connecting elements of the pre-column switching valve 13 in the first configuration I.

The port of the post-column switching valve 7, which may be have a fluidic connection to the first separation column 8, and the port of the post-column switching valve 7, which may have a fluidic connection to the detector 22, may be fluidly connected by means of the connecting elements of the post-column switching valve 7 in the first configuration I. The port of the post-column switching valve 7, which may be have a fluidic connection to the second separation column 5, and the port of the post-column switching valve 7, which may have a fluidic connection to the waste, may be fluidly connected by means of the connecting elements of the post-column switching valve 7 in the first configuration I.

The present invention, according a preferred embodiment, is at least in part directed to supplying a flow from the first separation column 8 into the detector 22 by means of the separation pump 1, in the first configuration I, as depicted in the preferred embodiment of FIG. 2. The first configuration I may be referred to as “first steady state”. In the first configuration I, the separation pump creates a flow from the first separation column 8 into the detector 22.

The present invention, according a preferred embodiment, is also at least in part directed to supplying a flow from the second separation column 5 into the waste by means of the reconditioning pump 12 in the first configuration I.

The method may further comprise the injection of a sample into the liquid chromatography system via the injection valve 10 and the pushing of the sample into the second separation column 5 by means of the reconditioning pump 12 in the first configuration I.

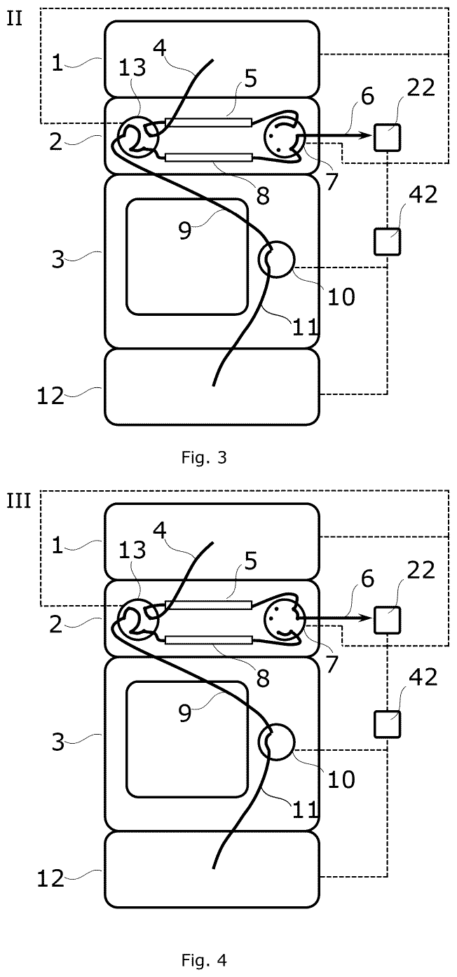

FIG. 3 depicts, as an example, a preferred embodiment of the system of FIG. 2 in a second configuration II.

The port of the pre-column switching valve 13, which may be have a fluidic connection to a port of the injection valve 10, and the port of the pre-column switching valve 13, which may have a fluidic connection to the first separation column 8, may be fluidly connected by means of the connecting elements of the pre-column switching valve 13 in the second configuration II. The port of the pre-column switching valve 13, which may be have a fluidic connection to the separation pump 1, and the port of the pre-column switching valve 13, which may have a fluidic connection to the second separation column 5, may be fluidly connected by means of the connecting elements of the pre-column switching valve 13 in the second configuration I.

The port of the post-column switching valve 13, which may be have a fluidic connection to the first separation column 8, and the port of the post-column switching valve 13, which may have a fluidic connection to the detector 22, may be fluidly connected by means of the connecting elements of the post-column switching valve in the second configuration II. The port of the post-column switching valve 13, which may be have a fluidic connection to the second separation column 5, and the port of the post-column switching valve 13, which may have a fluidic connection to the waste, may be fluidly connected by means of the connecting elements of the post-column switching valve 13 in the second configuration II.

The present invention is at least in part directed to supplying a flow from the first separation column 8 into the detector 22 by means of the reconditioning pump 12 in the second configuration II, as depicted in the preferred embodiment of FIG. 3. The second configuration II may be referred to as “first intermediate state”, wherein the reconditioning pump 12 creates a flow from the first separation column 8 into the detector 22.

The present invention is also at least in part directed to supplying a flow from the second separation column 5 into the waste by means of the separation pump 1 in the second configuration I as depicted in preferred the embodiment of FIG. 3.

The present invention is also at least in part directed to injecting a sample into the liquid chromatography system via the injection valve 10 and the pushing of the sample into the first separation column 8 by means of the reconditioning pump 12 in the second configuration II.

FIG. 4 depicts, as an example, a preferred embodiment of the system of FIG. 2 in a third configuration.

The port of the pre-column switching valve 13, which may be have a fluidic connection to a port of the injection valve 10, and the port of the pre-column switching valve 13, which may have a fluidic connection to the first separation column 8, may be fluidly connected by means of the connecting elements of the pre-column switching valve 13 in the third configuration. The port of the pre-column switching valve 13, which may be have a fluidic connection to the separation pump 1, and the port of the pre-column switching valve 13, which may have a fluidic connection to the second separation column, may be fluidly connected by means of the connecting elements of the pre-column switching valve 13 in the third configuration III.

The port of the post-column switching valve 13, which may be have a fluidic connection to the first separation column 8, and the port of the post-column switching valve 13, which may have a fluidic connection to the waste, may be fluidly connected by means of the connecting elements of the post-column switching valve 13 in the third configuration III. The port of the post-column switching valve 13, which may be have a fluidic connection to the second separation column 5, and the port of the post-column switching valve 13, which may have a fluidic connection to the detector 22, may be fluidly connected by means of the connecting elements of the post-column switching valve 13 in the third configuration III.

The present invention is at least in part directed to supplying a flow from the first separation column 8 into the waste by means of the reconditioning pump 12 in the third configuration III, as depicted in the preferred embodiment of FIG. 3.

The present invention is also at least in part directed to supplying a flow from the second separation column 5 into the detector 22 by means of the separation pump 1 in the third configuration III, as depicted in the preferred embodiment of FIG. 3. The third configuration III may be referred to as “second steady state”, wherein the separation pump 1 creates a flow from the second separation column 5 into the detector 22.

The present invention is also at least in part directed to injecting a sample into the liquid chromatography system via the injection valve 10 and the pushing of the sample into the first separation column 8 by means of the reconditioning pump 12 in the third configuration III.

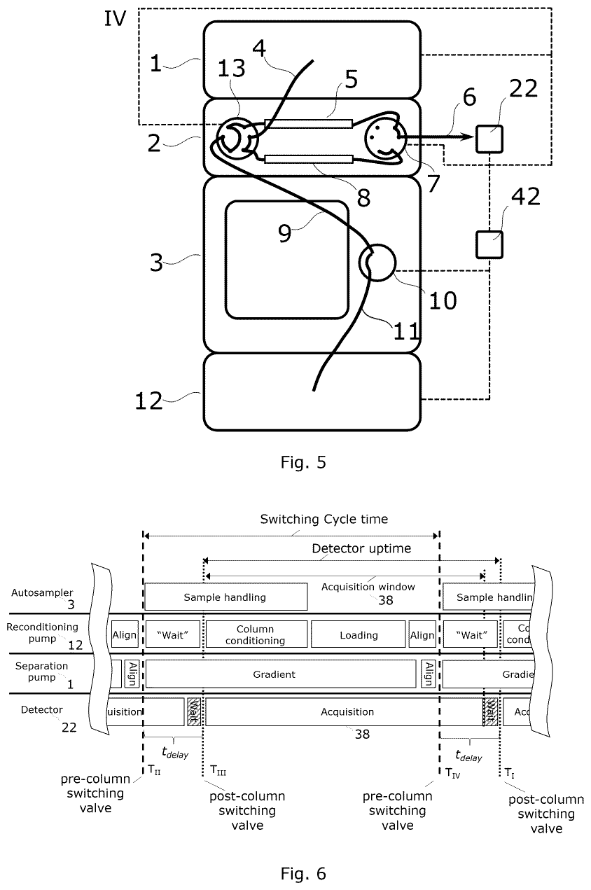

FIG. 5 depicts, as an example, a preferred embodiment of the system of FIG. 2 in a fourth configuration.

The port of the pre-column switching valve 13, which may be have a fluidic connection to a port of the injection valve 10, and the port of the pre-column switching valve, which may have a fluidic connection to the second separation column 5, may be fluidly connected by means of the connecting elements of the pre-column switching valve 13 in the fourth configuration IV. The port of the pre-column switching valve 13, which may be have a fluidic connection to the separation pump 1, and the port of the pre-column switching valve 13, which may have a fluidic connection to the first separation column 8, may be fluidly connected by means of the connecting elements of the pre-column switching valve 13 in fourth configuration IV.

The port of the post-column switching valve 13, which may be have a fluidic connection to the first separation column 8, and the port of the post-column switching valve 13, which may have a fluidic connection to the waste, may be fluidly connected by means of the connecting elements of the post-column switching valve 13 in the fourth configuration IV. The port of the post-column switching valve 13, which may be have a fluidic connection to the second separation column 5, and the port of the post-column switching valve 13, which may have a fluidic connection to the detector 22, may be fluidly connected by means of the connecting elements of the post-column switching valve 13 in the fourth configuration III.

The present invention is at least in part directed to supplying a flow from the first separation column 8 into the waste by means of the separation pump 1 in the fourth configuration IV, as depicted in the preferred embodiment of FIG. 4.

The present invention is also at least in part directed to supplying a flow from the second separation column 5 into the detector 22 by means of the reconditioning pump 12 in the fourth configuration IV, as depicted in the preferred embodiment of FIG. 4. The fourth configuration IV may be referred to as “second intermediate state”, wherein the reconditioning pump 12 creates a flow from the second separation column 5 into the detector 22.

The present invention is also at least in part directed to injecting of a sample into the liquid chromatography system via the injection valve 10 and the pushing of the sample into the second separation column 5 by means of the reconditioning pump 12 in the fourth configuration IV.

Furthermore, as depicted in FIG. 2, FIG. 3, FIG. 4 and FIG. 5, the system may also comprise a controller 42. The controller 42 can be operatively connected to other components, as depicted by dashed lines in FIG. 2, FIG. 3, FIG. 4 and FIG. 5. For instance, the controller 42 may be operatively connected to the reconditioning pump 12, to the injection valve 10, to the detector 22, to the post-column switching valve 7, to any component that may serve, at least in part, a similar purpose to the column switching valve 7, to the separation pump 1, and to the pre-column switching valve 13. The controller 420 can include a data processing unit and may be configured to control the system and carry out particular method steps. The controller can send or receive electronic signals for instructions. The controller can also be referred to as a microprocessor. The controller can be contained on an integrated-circuit chip. The controller can include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system.

FIG. 6 depicts an exemplary visualization of a workflow of a tandem liquid chromatography system with optimized acquisition time window based on four configurations of the tandem liquid chromatography system.

The present invention is at least in part directed to using a tandem direct injection workflow of a liquid chromatography system with optimized elution time window and optimized detection time window, based on the four configurations of the preferred embodiments of FIG. 2 to FIG. 5.

In particular, the elution window and the window for detector data acquisition may be aligned such, that consistent, reproducible chromatograms are obtained at optimum throughput, without relevant portions of the chromatogram being lost. This approach may be particularly beneficial with regard to tandem LC applications.

More in particular, four moments in time may be significant: a first switching time T_{II}, a second switching time T_{III}, a third switching time T_{IV} and a fourth switching time T_{I}, wherein T_{I} is later than T_{IV}, which is later than T_{III}, which is later than T_{II}. The system may be switched from the first configuration I to the second configuration II at the first switching time T_{II}. The system may be switched from the second configuration II to the third configuration III at the second switching time T_{III}. The system may be switched from the third configuration III to the fourth configuration IV the third switching time T_{IV}. The system may be switched from the fourth configuration IV back to the first configuration I at the fourth switching time T_{I}. In other words, the invention relates to a process where the system is switched among four configurations. The process may be a cyclic process, i.e. a process that repeats itself.

The system, in particular, may be switched from a “steady” state of the first configuration I to an “intermediate” state of the second configuration II, and subsequently to a “steady” state of the third configuration III, and subsequently to an “intermediate” state of the fourth configuration IV. It will be understood that a “steady” state of the liquid chromatography system identifies a state where the separation pump 1 provides a flow, via the first 8 or the second separation column 4, into the detector. It will also be understood that a “temporary” state of the liquid chromatography identifies a state where the reconditioning pump 12 provides a flow, via the first 8 or the second separation column 4, into the detector.

The time difference between T_{III} and T_{II} may be identified with t_{delay}. The time difference between T_{I} and T_{IV} may also be identified with t_{delay}.

With regard to the preferred embodiment of FIG. 6, the liquid chromatography system is intended to be in the first configuration I right before T_{II}. At T_{II} the pre-column switching valve 13 can switch the system from the first configuration I to the second configuration II. At T_{II}, a fluidic connection between the separation pump 1, the second separation column 5 and the waste can be achieved.

In other words, at T_{II}, the pre-column switching valve 13 may be switched to direct the gradient flow, which is simultaneously started, to the freshly conditioned second separation column 5. Simultaneously, the reconditioning pump 12 may deliver the last fraction of the gradient, that may have been generated by the separation pump 1 in a preceding step in the cycle through the first separation column 5, towards the post-column switching valve 7 where it may be directed towards the detector 22. There the compounds which may have been eluted from this last fraction of the gradient can be detected. During this phase, the flow rate of the reconditioning pump 12 may preferably be identical to the gradient flow rate of the separation pump 1, to assure consistent flow of the gradient solvents to the detector 22.

The separation pump 1 can start providing a gradient at T_{II}, thereby starting an elution window. However, the detector may not start a new acquisition window 38 yet. This is due to the fact that the gradient, started at T_{II}, may need an amount of time to traverse the fluidic connections between the separation pump 1 and the second separation column 5, and further to traverse the second separation column 5.

At T_{II}, furthermore, a fluidic connection between the reconditioning pump 12, the autosampler 3, the first separation column 8 and the detector 22 can be achieved.

The reconditioning pump 12 can provide a flow from the first separation column 8 into the detector 22. During this stage, which may be called “Wait”, the reconditioning pump 12 can push contents of the first separation column 8 into the detector 22. The flow rate of the reconditioning, during this stage, can be the same as the separation pump. The detector 22 may not start a new acquisition window 38 at T_{II}, but rather continue detecting in a previous acquisition window, and, in particular, continue detecting the flow from the first separation column 8 provided my means of the reconditioning pump 12. The detector can also stop detecting after T_{II} and before T_{III}, thereby ending the previous acquisition window, and wait to start a new acquisition window until T_{III}.

At T_{III} the post-column switching valve 7 can switch the system from the second configuration II to the third configuration III.

At T_{III}, a fluidic connection between the separation pump 1, the second separation column 5 and the detector 22 can be achieved.

The separation pump 1 may have started providing the gradient at T_{II}. Therefore, at T_{III}, the gradient provided by the separation pump may have had the time to traverse the fluidic connections between the separation pump 1 and the second separation column 5, and further the second separation column 5, and further the fluidic connection between the second separation column 5 and the detector 22. Therefore, at T_{III}, the detector 22 may start detecting in an acquisition window 38.

At T_{III}, furthermore, a fluidic connection between the reconditioning pump 12, the autosampler 3, the first separation column 8 and the waste can be achieved.

The reconditioning pump 12 can provide a flow from the first separation column 8 into the waste. During this stage, the reconditioning pump 12 conditions the first separation column 8. The flow rate of the reconditioning pump 12, during this stage, can be the larger than the separation pump 1. It will be understood that the autosampler 3 may start injecting a sample into the liquid chromatography system at T_{II} and may stop injecting the sample into the liquid chromatography after T_{III} and before T_{IV}.

In other words, at T_{III}, which may be at t_{delay} after T_{I}, the post-column switching valve 7 may switch and the flow from the second separation column 5, which may contain solvent at a gradient start condition (for example, 16), may be directed towards the detector 22. In the case of the reconditioning pump 12, at timepoint at T_{III}, which may be at t_{delay} after T_{I}, the reconditioning pump 12 will have delivered the last fraction of the gradient representing the gradient end concentration (for example, 17) through the post-column switching valve 7 towards the detector 22. It may now start conditioning the first separation column 8. To this, the flow of the reconditioning pump 12 may be increased to speed up washing and equilibration of the first separation column 8. At the post-column switching valve 7 the flow may be directed towards a waste container.

It should be noted that in the case that a mass spectrometry detector with a double barrel electrospray source is used for detection, instead of a post-column switching valve 7, also a switching of the high voltage between the two electro-sprayers could be applied, analogously, to act as the switching of the post-column switching valve 7.

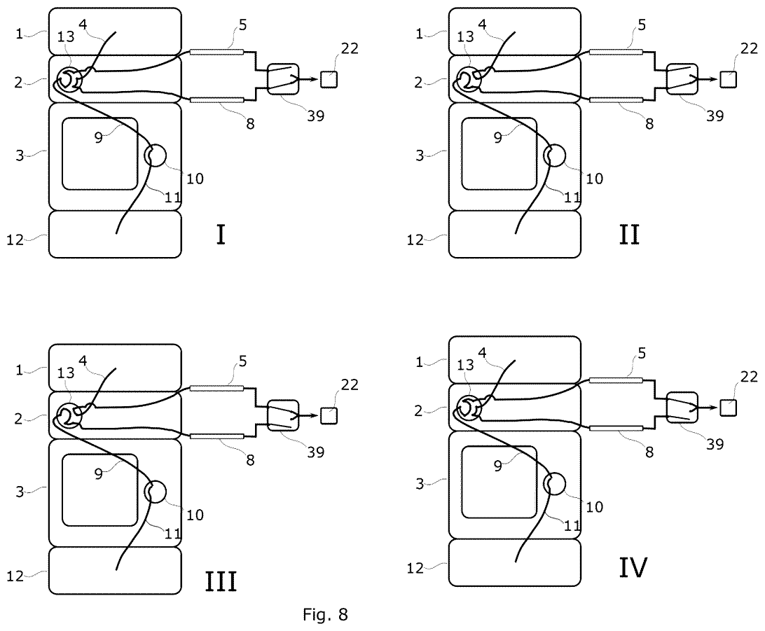

Embodiments regarding the use of a mass spectrometry detector with a double barrel electrospray source is used for detection, instead of a post-column switching valve 7, will be discussed with regard to FIG. 8.

At T_{IV} the pre-column switching valve 13 can switch the system from the third configuration III to the fourth configuration IV.

At T_{IV}, a fluidic connection between the separation pump 1, the first separation column 8 and the waste can be achieved.

The separation pump 1 can start providing the gradient at T_{IV}, thereby starting an elution window. However, the detector may not start a new acquisition window yet. This is due to the fact that the gradient may need an amount of time to traverse the fluidic connections between the separation pump 1 and the first separation column 8, and further to traverse the first separation column 8.

At T_{IV}, furthermore, a fluidic connection between the reconditioning pump 12, the autosampler 3, the second separation column 5 and the detector 22 can be achieved.

The reconditioning pump 12 can provide a flow from the second separation column 5 into the detector 22. During this stage, which may be called “Wait”, the reconditioning pump 12 can push the contents of second separation column 5 into the detector 22.

In other words, the last fraction of the gradient, provided by the separation pump 1 into the second separation column 5 starting from T_{II}, can be eluted into the detector by the reconditioning pump 12 starting from T_{IV}. The flow rate of the reconditioning pump 12, during this stage, can be the same as the separation pump 1.

The detector 22 may not start a new acquisition window at T_{IV}, but rather continue detecting, and, in particular, continue detecting the flow from the second separation column 5 provided my means of the reconditioning pump 12. In other words, the detector 22 may continue detecting the last fraction of the gradient, provided by the separation pump 1 into the second separation column 5 the starting from T_{II}. The detector can also stop detecting after T_{IV}, thereby ending the acquisition window 38, and before T_{I} and wait to start a new acquisition window until T_{I}.

At T_{I} the post-column switching valve 7 can switch the system from the fourth configuration IV back to the first configuration I.

At T_{I}, a fluidic connection between the separation pump 1, the first separation column 8 and the detector 22 can be achieved.

The separation pump 1 can start providing the gradient at Tv. Therefore, at T_{I}, the gradient provided by the separation pump 1 may have had the time to traverse the fluidic connections between the separation pump 1 and the first separation column 8, and further the first separation column 8, and further the fluidic connection between the first separation column 8 and the detector 22. Therefore, at T_{I}, the detector 22 may start detecting in a new acquisition window.

At T_{I}, furthermore, a fluidic connection between the reconditioning pump 12, the autosampler 3, the second separation column 5 and the waste can be achieved.

The reconditioning pump 12 can provide a flow from the second separation column 5 into the waste. During this stage, the reconditioning pump 12 conditions the second separation column 5. The flow rate of the reconditioning pump 12, during this stage, can be the larger than the separation pump 1. It will be understood that the autosampler 3 may start injecting a sample into the liquid chromatography system at T_{I}.

It will be understood that the system, after T_{I}, can repeat the process described in relation to the embodiment of FIG. 6 in a periodic manner, switching from the first configuration I to the second configuration II at a time T_{II}′, which is later than T_{I}. In other words, a cyclic process may be realized by system, wherein the system is switched among four configurations.

The subsequent cycle follows the same temporal sequence such that times T_{II}′, T_{III}′, T_{IV}′, T_{I}′ of the subsequent cycle correspond, respectively, to the times T_{II}, T_{III}, T_{IV}, T, in terms of temporal as well as functional characteristics.

The present invention is furthermore at least in part directed to optimizing the time difference t_{delay} between T_{III} and T_{II}, and between T_{I} and T_{IV}. The optimization of the time difference t_{delay} can lead, for example in a tandem chromatography system, to consistent and reproducible chromatograms, where a single detection window can contain only and all of the chromatographic peaks of a single compound and/or group of compounds of interest. The optimization of the time difference t_{delay} can further lead, for example in a tandem chromatography system, to an optimum throughput of the tandem chromatography system.

In other words, because of the optimized delay between T_{III} and T_{II}, and between T_{I} and T_{IV}, the detector widow of acquisition can be optimally aligned with respect to the time when the single compound and/or group of compounds of interest reach the detector.

Generally, embodiments of the present invention may be described as follows. FIG. 2 depicts a liquid chromatography system in a first configuration I. In this configuration, the separation pump 1 is connected to the first separation column 8 and further to the detector 22. Furthermore, the reconditioning pump 12 is fluidly connected to the second separation column 5 and to a waste (not depicted in FIG. 1). This is a “normal” or steady state, where the second separation column 5 may be reconditioned and the separation pump 1 may provide a gradient to the first separation column 8 and further to the detector 22.

It will be understood that FIG. 4 depicts another “normal” or steady state, where the separation pump 1 is connected to the second separation column 5 and to the detector 22, and the reconditioning pump 12 is connected to the first separation column 8 and to the waste.

Embodiments of the present invention are directed in that the system additionally also assumes the state or configuration II depicted in FIG. 3 and/or IV depicted in FIG. 5. In the configuration II in FIG. 3, the reconditioning pump 12, which may also be referred to as second pump 12, is connected to the first separation column 8 to the detector 22. That is, different to the configurations I and III depicted in FIGS. 2 and 4, the system also assumes a configuration, wherein the second pump 12 is connected to the detector.

The system is switched from the configuration I in FIG. 2 to the configuration II in FIG. 2 at a first switching time T_{II}′, the index denoting the configuration the system is switched to. At the first switching time T_{II}, it is preferred that the solvent composition and the flow rate delivered by the second pump 12 is identical to the one delivered by the separation pump 1. It will be understood that the flow rate and solvent composition should be identical as delivered at the pre-column switching valve 13, as this is where the change of the fluidic connections becomes effective.

As discussed above, there generally is a delay time t_{delay} between when a certain solvent composition is present at the separation pump 1 (as part of a gradient operation) and when this solvent composition arrives at the detector 22. In embodiments of the present invention, the system is operated in the configuration II of FIG. 3 for a duration corresponding to this delay time t_{delay}. That is, for a duration t_{delay}, fluid is delivered from the first separation column 8 to the detector 22 by means of the second pump 12.

This is also depicted in FIG. 6. According to this Figure, the pre-column switching valve 13 is switched at time T_{II}′. Subsequently, for the delay time t_{delay}, the reconditioning pump 12 “waits”, i.e., is used to effect a flow from the first separation column 8 to the detector 22. During this time, there is data acquisition and a short wait time at the detector 22.

Once the last part of the gradient has reached the detector 22, the system is switched from the configuration II in FIG. 3 to the configuration III in FIG. 4. In this configuration, the first separation column 8 is connected to the reconditioning pump 12 and to the waste. Further, the second separation column 5 is connected to the separation pump 12 and to the detector 22. Relating to the separation column 5, reference is again made to the configuration II of FIG. 3. In this configuration II, the second separation column 5 is already connected to the separation pump 1. However, it is not yet connected to the detector 22, but to the waste. In this configuration, the separation pump 1 may start its gradient delivery (see FIG. 6 at the first switching time T_{II}). Again, it will be understood that a solvent composition provided by the separation pump at a certain point of time will only reach downstream components later. In particular, this solvent composition at the start of the gradient delivery may take approximately the delay time t_{delay} to reach the post-column switching valve. Only at this point of time, the solvent present at the post-column switching valve may be of interest for further detection. Thus, at the second switching time T_{III}, which is the delay time t_{delay} later than the first switching time T_{II}, the system may be switched from the second configuration II of FIG. 3 to the third configuration III of FIG. 4. At this time, a new data acquisition time window may start (see 38 in FIG. 6), which corresponds to the gradient delivered by the separation pump 1 arriving at the detector 22.

Furthermore, it will be appreciated that in the configuration III of FIG. 4, the first separation column 8 is no longer connected to the detector 22, but to waste. In this configuration, the first separation column 8 may thus be reconditioned. This is depicted in FIG. 6, where, staring at the third switching time T_{III}, the reconditioning pump 12 provides a column reconditioning. It should be understood that this column reconditioning may be performed with flow rates different from the flow rate delivered during the gradient delivery. In particular, it may be performed with higher flow rates. After the first separation column 8 has been reconditioned, it may be loaded with another sample. Further, the reconditioning pump 12 may perform an aligning step before the third switching time T_{IV}.

In this regard, it will be understood that the fourth configuration IV depicted in FIG. 5 essentially corresponds to the second configuration II depicted in FIG. 3, but with reversed roles for the first separation column 8 and the second separation column 5. Again, the second separation column 5, in the configuration III assumed before configuration IV, is connected to the separation pump 1 and to the detector 22. In the configuration IV (see FIG. 5), the second separation column 5 is still connected to the detector 22, but no longer to the separation pump 1, but instead to the reconditioning pump 12. Similar to the configuration in FIG. 3, the reconditioning pump 12 effects the last sections of the gradient to flow from the second separation column 5 to the detector 22. Again, it may be beneficial if the operational parameters of the solvent provided a the third switching time T_{IV}, i . . . e, when the system switches to configuration IV depicted in FIG. 5, are identical for the separation pump 1 and the second pump 12, which may also be referred to as reconditioning pump 12. Again, it will be understood that when switching to the fourth configuration IV in FIG. 5, the reconditioning pump 12 takes over the function of the separation pump 1 in configuration IV. It is thus beneficial for the operational parameters (in particular flow rate and solvent composition) to be identical at the switching time T_{IV}. This is why prior to the switching time T_{IV} (see FIG. 6), the reconditioning pump 12 and the separation pump 1 are aligned with one another, meaning that there operational parameters are identical at the switching time T_{IV}. At T_{IV}, the pre-column switching valve is switched, such that the configuration IV of FIG. 5 is assumed.

Again, this configuration IV essentially corresponds to the configuration II of FIG. 3, with the roles of the separation columns 5 and 8 reversed. It will thus be understood that at a fourth switching time T_{I}, the system may again switch to configuration I depicted in FIG. 2 and that the overall operation be cyclical between the configurations I, II, III, and IV.

With regard to FIG. 6, the following considerations will be appreciated. Firstly, as described, the fluid is caused to arrive at the detector 22 both by the separation pump 1 and the reconditioning pump 12 (see boxes indicating with “wait” for the reconditioning pump 12 in FIG. 6 and configurations II and IV, where the reconditioning pump 12 is connected to the detector 22). Secondly, the acquisition time windows 38 are shifted with regard to the gradient delivery of the separation pump 1 (see FIG. 6) to account for time delay t_{delay} between a certain solvent composition being delivered by the pump and arriving at the detector 22.

Overall, embodiments of the present technology thus allow for an increased usage time of the described system. In particular, the detector 22 may be supplied with solvents containing samples a higher percentage of the time as compared to other configurations. Further, by shifting the data acquisition time windows, signals may be more correctly assigned to a certain sample than is possible without such a shift.

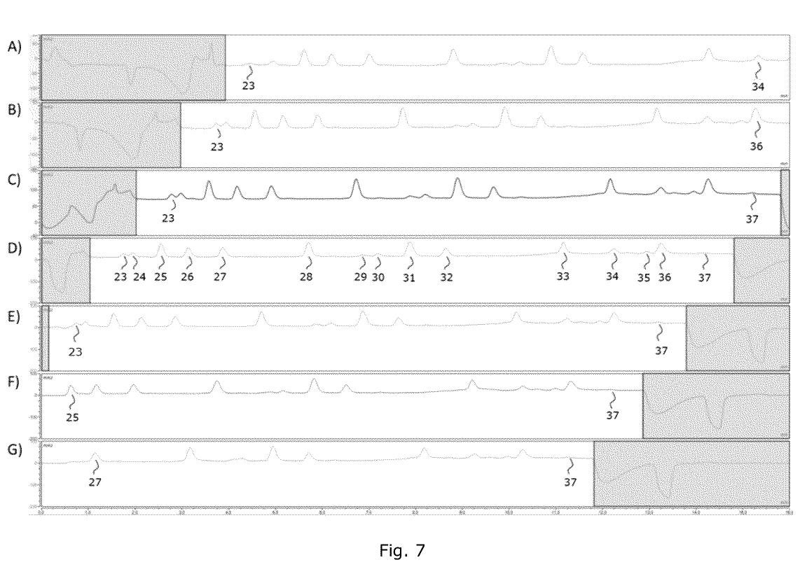

FIG. 7 illustrates, as an example, UV chromatograms of Cytochrome C showing the influence on UV chromatograms of Cytochrome C of the time difference between the start of detector acquisition and the start of gradient delivery in a liquid chromatography system.

More specifically, in FIG. 7, at the example of a UV Chromatogram of Cytochrome C, the elution window and thus the resulting chromatogram is step-wise shifted to the left by adjusting the start of the detector acquisition relative to the start of the gradient delivery.

The grey areas of the chromatograms of the embodiment of FIG. 7 indicate areas of the chromatograms that are not included in the detection window. The full UV chromatogram of Cytochrome C, can show fifteen peaks, with a first peak 23 and a last peak 37 in the sequence.

FIG. 7A depicts a UV chromatogram of Cytochrome C measured with a delay time of zero minutes between the start of detector acquisition and the start of gradient delivery in a liquid chromatography system. In this case, the last peaks 35, 36, and 37 in the sequence of peaks of the full UV chromatogram of Cytochrome C may not be included in the detection window.

FIG. 7B depicts a UV chromatogram of Cytochrome C measured with a delay time of one minute between the start of detector acquisition and the start of gradient delivery in a liquid chromatography system. In this case, the last peaks 36, and 37 (see FIG. 7 D) in the sequence of peaks of the full UV chromatogram of Cytochrome C may not be included in the detection window.

Overall, peaks at the “far end” (i.e. at high retention times) of the chromatogram may be missing, as illustrated in FIG. 7A and FIG. 7B.

FIG. 7C depicts a UV chromatogram of Cytochrome C measured with a delay time of three minutes between the start of detector acquisition and the start of gradient delivery in a liquid chromatography system. In this case, all peaks in the sequence of peaks of the full UV chromatogram of Cytochrome C may be included in the detection window.

FIG. 7D depicts a UV chromatogram of Cytochrome C measured with a delay time of four minutes between the start of detector acquisition and the start of gradient delivery in a liquid chromatography system. In this case, all peaks in the sequence of peaks of the full UV chromatogram of Cytochrome C may be included in the detection window.

FIG. 7E depicts a UV chromatogram of Cytochrome C measured with a delay time of five minutes between the start of detector acquisition and the start of gradient delivery in a liquid chromatography system. In this case, all peaks in the sequence of peaks of the full UV chromatogram of Cytochrome C may be included in the detection window.

Overall, all peaks may be present in the chromatogram, as illustrated in FIG. 7C, FIG. 7D and FIG. 7E.

FIG. 7F depicts a UV chromatogram of Cytochrome C measured with a delay time of six minutes between the start of detector acquisition and the start of gradient delivery in a liquid chromatography system. In this case, the first peaks 23, and 24 in the sequence of peaks of the full UV chromatogram of Cytochrome C may not be included in the detection window.

FIG. 7G depicts a UV chromatogram of Cytochrome C measured with a delay time of seven minutes between the start of detector acquisition and the start of gradient delivery in a liquid chromatography system. In this case, the first peaks 23, 24, 25, and 26 in the sequence of peaks of the full UV chromatogram of Cytochrome C may not be included in the detection window.

Overall, if the time difference between the start of detector acquisition and the start of gradient delivery is even further increased, the resulting chromatograms may be lacking the first part of the eluting compounds to an increasing degree, as illustrated FIG. 7F and FIG. 7G.

Overall, this shows that a suitable delay time t_{delay} should ideally be chosen to include all the relevant peaks for a sample analysis. In the depicted example, delay times t_{delay} of 2, 3 and 4 minutes (see FIGS. 7 C), D), E)) would be suitable to include all the peaks in the chromatogram, and it will be understood that suitable delay times may either be found by a user, or by a software driven approach.

It will be understood that embodiments of the herein presented approach may allow the period in which no compounds may be eluted from a separation column owing to a lack of eluting solvents during this time can be reduced (see, e.g., the shaded areas in FIG. 7). This may allow to reduce the cycle time and thus increase the throughput. Additionally, it may save storage space as no detector data may be recorded during the timeframe that does not contain any data that would be relevant for the analysis.

FIG. 8 depicts, as an example, preferred embodiments of a liquid chromatography system utilizing a double barrel electrospray source and adopting four configurations according to embodiments of the present invention.

The configuration I, II, III, IV of FIG. 8 may correspond, at least in part, to features of, e.g., the embodiments of any of the preceding figures.

The liquid chromatography system may comprise a double barrel electrospray source 39. The double barrel electrospray source 39 may be used, for instance, in place of the post-column switching valve 7 of the embodiments of FIG. 2, FIG. 3, FIG. 4, and/or FIG. 5. The liquid chromatography system may comprise a detector 22, which may be mass spectrometry detector.

A double barrel electrospray source 39 may allow to selectively introduce fluid from one of the separation columns 5, 8 into the detector 22, while for example connecting the other separation column 8, 5 to waste (not depicted).

In the embodiment depicted in FIG. 8, the first separation column 8 and the second separation column 5 are not contained in the column compartment 2. Instead, they may be contained in a column heater outside the column compartment 2.

Also in this embodiment, a detector 22 is provided, which may be a mass spectrometer (MS) 22. The first separation column 8 and the second separation column 5 may be arranged close to the detector 22. Each of the columns 5, 8 may comprise an outlet. The outlet of the first column 8 may be connected to a first emitter and the outlet of the second column 5 may be connected to a second emitter. The emitters are configured to spray directly into the MS 22. Generally, the system is configured to selectively apply a high voltage to one of the emitters. Thus, only the liquid arriving at the emitter where the high voltage is applied is sprayed into the detector chamber. This functionality is depicted in FIG. 8 by element 39. Selectively applying the high voltage thus effectively has the functionality of a valve, as only the liquid at the emitter where the high voltage is applied is sprayed towards the detector. In configurations I and II, the emitter connected to the first separation column 8 is supplied with high voltage, such that liquid in this branch is supplied to the MS 22, while in configurations III and IV, the emitter connected to the second separation column 5 is supplied with high voltage, such that liquid in this branch is supplied to the MS 22. Overall, this therefore defines two different “barrels” which may be “connected” to the MS 22 by applying the high voltage, which is why this system may also be referred to as a double barrel electrospray system.

As discussed, the columns 5, 8 may be located outside of the column compartment and generally close to the MS detector 22. Thus, at the outlet of the columns, there is directly the emitter where the electrospray is generated. This spray advantageously is in direct vicinity of an inlet of the MS 22 to allow for transfer of the generated charged species into the MS 22.

Generally, the liquid chromatography system depicted in FIG. 8 may be configured in such a way that a high voltage is applied to only a barrel at a time for electrospray ionization, i.e. to either the first barrel or to the second barrel at a time. Put differently, only one emitter at a time may spray into the detector 22. For example, the first barrel may be subject to a high voltage and the first emitter of the first barrel may therefore spray into the detector 22, while the contents of the second barrel may evaporate while traversing the second barrel or be directed to a waste, both of which is referred to as the barrel or the respective separation column being fluidly connected to waste. Vice versa, the second barrel may be subject to a high voltage and the second emitter of the second barrel may therefore spray into the detector 22, while the contents of the first barrel may evaporate while traversing the first barrel or be directed to a waste, i.e., the first barrel is fluidly connected to waste.

By alternatively switching the high voltage that the first barrel and of the second barrel are subject to, the double barrel electrospray source 39 may serve, at least in part, a similar purpose to the post column switching valve 7 depicted in FIGS. 2 to 5. The use of the double barrel electrospray source 39 may be preferably employed when, e.g., the flowrates determined by a pump for liquid chromatography are smaller than 1 μL/min, as in, for instance, nano flow liquid chromatography-mass spectrometry applications. The use of the double barrel electrospray source 39 may have the benefit that the volume of the fluidic connection between at least one separation column and the detector in a liquid chromatography may be minimized. This may result in lower dispersion and lower gradient delay resulting in better chromatographic performance in terms of, but limited to, peak resolution and/or throughput.

In one embodiment of FIG. 8, the first barrel may be subject to a high voltage in the first configuration I and the first emitter of the first barrel may therefore be enabled to spray into the detector 22 in the first configuration I. In one embodiment of FIG. 8, the first barrel may be subject to a high voltage in the second configuration II and the first emitter of the first barrel may therefore be enabled to spray in to the detector 22 in the second configuration II. In one embodiment of FIG. 8, the second barrel may be subject to a high voltage in the third configuration III and the second emitter of the second barrel may therefore be enabled to spray in to the detector 22 in the third configuration III. In one embodiment of FIG. 8, the second barrel may be subject to a high voltage in the fourth configuration IV and the second emitter of the second barrel may therefore be enabled to spray in to the detector 22 in the fourth configuration IV.

Generally, it will thus be understood that the first configuration I depicted in FIG. 8 functionally corresponds to the configuration I depicted in FIG. 2. In this configuration, the separation pump 1 is connected to the first separation column 8, and the high voltage is supplied to the first barrel, such that the first emitter of the first barrel sprays into the detector 22 (which functionally corresponds to the first separation column 8 being connected to the detector).

Furthermore, the configuration II in FIG. 8 generally corresponds to the configuration II depicted in FIG. 3. In this configuration, the reconditioning pump 12 is fluidly connected to the first separation column 8, and the high voltage is supplied to first barrel, such that the first emitter of the first barrel sprays into the detector 22.

Similarly, it will be understood that the configurations III and IV depicted in FIG. 8 generally correspond to the configurations III and IV depicted in FIGS. 4 and 5, respectively.

The skilled person will thus understand that advantages as described above for the system comprising a post-column switching valve 7 may also be achieved when using the system of FIG. 8 with a double barrel electrospray source.

In this regards, it will also be understood that a controller 42 as depicted in FIGS. 2 to 5 is also typically present in the system of FIG. 8, but has been omitted in FIG. 8 for ease of illustration.

Whenever a relative term, such as “about”, “substantially”, “essentially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A method performed in a liquid chromatography system, the method comprising: in a first configuration (I), wherein a first separation column is fluidly connected to a separation pump and a detector, supplying a flow from the first separation column towards the detector by means of the separation pump in the first configuration (I), and
switching the liquid chromatography system from the first configuration (I) to a second configuration (II), wherein the first separation column is fluidly connected to a second pump and to the detector, and supplying a flow from the first separation column towards the detector by means of the second pump in the second configuration (II).

2. The method according to claim 1,
wherein in the first configuration (I) a second separation column is fluidly connected to the second pump and to a waste,
wherein the method further comprises supplying a flow from the second separation column towards the waste by means of the second pump in the first configuration (I),
wherein in the second configuration (II), the second separation column is fluidly connected to the separation pump and to the waste, wherein the method further comprises supplying a flow from the second separation column towards the waste by means of the separation pump in the second configuration (II).

3. The method according to claim 1,
wherein the liquid chromatography system is switched from the first configuration (I) to the second configuration (II) at a first switching time (T_{II}),
wherein the method comprises switching the liquid chromatography system from the second configuration (II) to a third configuration (III), wherein the first separation column is fluidly connected to the second pump and to a waste,
wherein the method further comprises supplying a flow from the first separation column towards the waste by means of the second pump in the third configuration (III),
wherein the liquid chromatography system is switched from the second configuration (II) to the third configuration at a second switching time (T_{III}), and
wherein the second switching time (T_{III}) is later than the first switching time (T_{II})

4. The method according claim 3,
wherein the method comprises switching the liquid chromatography system from the third configuration (III) to a fourth configuration (IV), wherein the first separation column is fluidly connected to the separation pump and to a waste,
wherein the method further comprises supplying a flow from the first separation column towards the waste by means of the separation pump in the fourth configuration (IV), and
wherein the liquid chromatography system is switched from the third configuration (III) to the fourth configuration (IV) at a third switching time (T_{IV}), wherein the third switching time (T_{IV}) is later than the second switching time (T_{III}).

5. The method according to claim 4,
wherein in the fourth configuration (IV), the second separation column is fluidly connected to the second pump and to the detector, and wherein the method further comprises supplying a flow from the second separation column towards the detector by means of the second pump in the fourth configuration (IV).

6. The method according to claim 4,
wherein the liquid chromatography system is switched from the fourth configuration (IV) back to the first configuration (I) at a fourth switching time (T_{I}), thereby forming a cyclic process and thereby ending a previous cycle and thereby starting a subsequent cycle,
wherein the fourth switching time (T_{I}) is later than the third switching time (T_{IV}),
wherein the subsequent cycle follows the same temporal sequence such that times T_{II}′, T_{III}′, T_{IV}′, T_{I}′ of the subsequent cycle correspond, respectively, to the times T_{II}, T_{III}, T_{IV}, T_{I} of the previous cycle.

7. The method according to claim 6,
wherein a time difference t_{delay} between the second switching time (T_{III}) and the first switching time (T_{II}) is based on a volume V₅ of the second separation column, on a volume V_{con} of fluidic connections connected to the second separation column, and on a flow rate F of the separation pump,
wherein a time difference t_{delay}′ between the fourth switching time (T_{I}) and the third switching time (T_{IV}) is based on a volume V₈′ of the first separation column, on a volume V_{con}′ of fluidic connections connected to the first separation column, and on a flow rate F of the separation pump.

8. The method according to claim 6,
wherein the liquid chromatography system comprises a pre-column switching valve,
wherein the liquid chromatography system comprises a post-column switching valve,
wherein the method comprises switching, via the pre-column switching valve, the liquid chromatography system from the first configuration (I) to the second configuration (II) at the first switching time T_{II},
wherein the method comprises switching, via the pre-column switching valve, the liquid chromatography system from the third configuration (III) to the fourth configuration (IV) at the third switching time T_{IV},
wherein the method comprises switching, via the post-column switching valve, the liquid chromatography system from the second configuration (II) to the third configuration (III) at the second switching time T_{III},
wherein the method comprises switching, via the post-column switching valve, the liquid chromatography system from the fourth configuration (IV) to the first configuration (I) at the fourth switching time T_{I}.

9. The method according to claim 7,
wherein the method comprises utilizing an optimization procedure to optimize the time difference t_{delay} and/or the time difference t_{delay}′,
wherein the method comprises using a user interface, at least in part, in the steps of the optimization procedure.

10. A system for liquid chromatography, the system comprising:
a first separation column,
a separation pump, and
a detector,
wherein the first separation column is configured to be fluidly connected to the separation pump and the detector in a first configuration (I),
wherein the system is configured to supply a flow from the first separation column towards the detector by means of the separation pump in the first configuration (I), and
wherein the system is configured to switch the system from the first configuration (I) to a second configuration (II),
wherein the first separation column is configured to be fluidly connected to the second pump and to the detector in the second configuration (II), and
wherein the system is configured to supply a flow from the first separation column towards the detector by means of the second pump in the second configuration (II).

11. The system according to claim 10,
wherein the system further comprises:
a second separation column, and
a waste,
wherein the second separation column is configured to be fluidly connected to the second pump and to the waste in the first configuration (I),
wherein the system is configured to supply a flow from the second separation column towards the waste by means of the second pump in the first configuration (I).

12. The system according to claim 10,
wherein the system is configured to switch the system from the first configuration (I) to the second configuration (II) at a first switching time (T_{II}),
wherein the system is configured to switch the system from the second configuration (II) to a third configuration (III), wherein the first separation column configured to be fluidly connected to the second pump and to a waste, and wherein the system is configured to supply a flow from the first separation column towards the waste by means of the second pump in the third configuration (III),
wherein the system is configured to switch the system from the second configuration (II) to the third configuration at a second switching time (T_{III}),
wherein the second switching time (T_{III}) is later than the first switching time (T_{II}).

13. The system according to claim 12, wherein the system is configured to switch the system from the third configuration (III) to a fourth configuration (IV), wherein the first separation column is fluidly connected to the separation pump and to a waste, and wherein the system is configured to supply a flow from the first separation column towards the waste by means of the separation pump in the fourth configuration (IV).

14. The system according to claim 13, wherein in the fourth configuration (IV), the second separation column is fluidly connected to the second pump and to the detector, and wherein the system is configured to supply a flow from the second separation column towards the detector by means of the second pump in the fourth configuration (IV).

15. The system according to claim 13,
wherein system is configured to switch the system from the fourth configuration (IV) back to the first configuration (I) at a fourth switching time (T_{I}), thereby forming a cyclic process and thereby ending a previous cycle and thereby starting a subsequent cycle,
wherein the fourth switching time (T_{I}) is later than the third switching time (T_{IV}) and wherein a time difference t_{delay}′ between the fourth switching time (T_{I}) and the third switching time (T_{IV}) is based on a volume V₈′ of the first separation column, on a volume V_{con}′ of fluidic connections connected to the first separation column, and on a flow rate F of the separation pump.

16. The system according to claim 15,
wherein a time difference t_{delay} between the second switching time (T_{III}) and the first switching time (T_{II}) is based on a volume V₅ of the second separation column, on a volume V_{con} of fluidic connections connected to the second separation column, and on a flow rate F of the separation pump,
wherein a time difference t_{delay}′ between the fourth switching time (T_{I}) and the third switching time (T_{IV}) is based on a volume V₈′ of the first separation column, on a volume V_{con}′ of fluidic connections connected to the first separation column, and on a flow rate F of the separation pump.

17. The system according to claim 10,
wherein the liquid chromatography system comprises a pre-column switching valve,
wherein the pre-column switching valve comprises a plurality of ports and a plurality of connecting elements for interchangeably connecting the ports,
wherein
one port of the pre-column switching valve is fluidly connected to the separation pump,
one port of the pre-column switching valve is fluidly connected to the second pump, one port of the pre-column switching valve is fluidly connected to the first separation column,
one port of the pre-column switching valve is fluidly connected to the second separation column.

18. The system according to claim 16,
wherein the system is configured to utilize an optimization procedure to optimize the time difference t_{delay} and/or the time difference t_{delay}′.

19. A computer-readable medium comprising instructions which, when executed by a processor, cause the processor to control a system for liquid chromatography to carry out a method, the method comprising:
in a first configuration (I), wherein a first separation column is fluidly connected to a separation pump and a detector, supplying a flow from the first separation column towards the detector by means of the separation pump in the first configuration (I), and
switching the liquid chromatography system from the first configuration (I) to a second configuration (II), wherein the first separation column is fluidly connected to a second pump and to the detector, and supplying a flow from the first separation column towards the detector by means of the second pump in the second configuration (II).
